(19) United States
(12) Patent Application Publication
(10) Pub. No.: US 2025/0350911 A1
(43) Pub. Date: Nov. 13, 2025

(54) VEHICLE-TO-EVERYTHING (V2X)-ASSISTED BIRD'S EYE VIEW (BEV) SIGNALING FOR COOPERATIVE BEV PERCEPTION

(71) Applicant: QUALCOMM Incorporated, San Diego, CA (US)

(72) Inventors: Anantharaman BALASUBRAMANIAN, San Diego, CA (US); Varun RAVI KUMAR, San Diego, CA (US); Dan VASSILOVSKI, Del Mar, CA (US); Kiran BANGALORE RAVI, Paris (FR); Senthil Kumar YOGAMANI, Headford (IE)

(21) Appl. No.: 18/656,834

(22) Filed: May 7, 2024

(51) Int. Cl. H04W 4/40; G06V 20/56

(52) U.S. Cl. CPC H04W 4/40; G06V 20/56

(57) ABSTRACT

In some aspects, a vehicle-to-everything (V2X)-capable vehicle may determine an association between one or more features of a bird's eye view (BEV) space around the V2X-capable vehicle and one or more V2X messages, where the one or more features of the BEV space are associated with the one or more V2X messages based on one or more objects detected in the one or more features of the BEV space being reported in the one or more V2X messages. The V2X-capable vehicle may transmit one or more messages indicating the association and a set of BEV features representing the BEV space other than the one or more features of the BEV space associated with the one or more V2X messages.

### BACKGROUND OF THE DISCLOSURE

### 1. Field of the Disclosure

Aspects of the disclosure relate generally to wireless technologies.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)) and other technical enhancements.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by vehicle-to-everything (V2X)-capable vehicle includes determining an association between one or more features of a bird's eye view (BEV) space around the V2X-capable vehicle and one or more V2X messages, wherein the one or more features of the BEV space are associated with the one or more V2X messages based on one or more objects detected in the one or more features of the BEV space being reported in the one or more V2X messages; and transmitting one or more messages indicating the association and a set of BEV features representing the BEV space other than the one or more features of the BEV space associated with the one or more V2X messages.

In an aspect, a method of communication performed by a network entity includes receiving, from a first V2X-capable vehicle, one or more first messages indicating an association between one or more first features of a first bird's eye view (BEV) space around the first V2X-capable vehicle and one or more first V2X messages, wherein the one or more first features of the first BEV space is associated with the one or more first V2X messages based on one or more first objects detected in the one or more first features of the first BEV space being reported in the one or more first V2X messages, and wherein the one or more first messages further indicate a first set of BEV features representing the BEV space other than the one or more first features of the first BEV space associated with the one or more first V2X messages; determining an occupancy of a global BEV space based, at least in part, on properties of the one or more first objects reported in the one or more first V2X messages.

In an aspect, a vehicle-to-everything (V2X)-capable vehicle includes one or more memories; one or more transceivers; and one or more processors communicatively coupled to the one or more memories and the one or more transceivers, the one or more processors, either alone or in combination, configured to: determine an association between one or more features of a bird's eye view (BEV) space around the V2X-capable vehicle and one or more V2X messages, wherein the one or more features of the BEV space are associated with the one or more V2X messages based on one or more objects detected in the one or more features of the BEV space being reported in the one or more V2X messages; and transmit, via the one or more transceivers, one or more messages indicating the association and a set of BEV features representing the BEV space other than the one or more features of the BEV space associated with the one or more V2X messages.

In an aspect, a network entity includes one or more memories; one or more transceivers; and one or more processors communicatively coupled to the one or more memories and the one or more transceivers, the one or more processors, either alone or in combination, configured to: receive, via the one or more transceivers, from a first V2X-capable vehicle, one or more first messages indicating an association between one or more first features of a first bird's eye view (BEV) space around the first V2X-capable vehicle and one or more first V2X messages, wherein the one or more first features of the first BEV space is associated with the one or more first V2X messages based on one or more first objects detected in the one or more first features of the first BEV space being reported in the one or more first V2X messages, and wherein the one or more first messages further indicate a first set of BEV features representing the BEV space other than the one or more first features of the first BEV space associated with the one or more first V2X messages; and determine an occupancy of a global BEV space based, at least in part, on properties of the one or more first objects reported in the one or more first V2X messages.

In an aspect, a vehicle-to-everything (V2X)-capable vehicle includes means for determining an association between one or more features of a bird's eye view (BEV) space around the V2X-capable vehicle and one or more V2X messages, wherein the one or more features of the BEV space are associated with the one or more V2X messages based on one or more objects detected in the one or more features of the BEV space being reported in the one or more V2X messages; and means for transmitting one or more messages indicating the association and a set of BEV features representing the BEV space other than the one or more features of the BEV space associated with the one or more V2X messages.

In an aspect, a network entity includes means for receiving, from a first V2X-capable vehicle, one or more first messages indicating an association between one or more first features of a first bird's eye view (BEV) space around the first V2X-capable vehicle and one or more first V2X messages, wherein the one or more first features of the first BEV space is associated with the one or more first V2X messages based on one or more first objects detected in the one or more first features of the first BEV space being reported in the one or more first V2X messages, and wherein the one or more first messages further indicate a first set of BEV features representing the BEV space other than the one or more first features of the first BEV space associated with the one or more first V2X messages; and means for determining an occupancy of a global BEV space based, at least in part, on properties of the one or more first objects reported in the one or more first V2X messages.

In an aspect, a non-transitory computer-readable medium stores computer-executable instructions that, when executed by a vehicle-to-everything (V2X)-capable vehicle, cause the V2X-capable vehicle to: determine an association between one or more features of a bird's eye view (BEV) space around the V2X-capable vehicle and one or more V2X messages, wherein the one or more features of the BEV space are associated with the one or more V2X messages based on one or more objects detected in the one or more features of the BEV space being reported in the one or more V2X messages; and transmit one or more messages indicating the association and a set of BEV features representing the BEV space other than the one or more features of the BEV space associated with the one or more V2X messages.

In an aspect, a non-transitory computer-readable medium stores computer-executable instructions that, when executed by a network entity, cause the network entity to: receive, from a first V2X-capable vehicle, one or more first messages indicating an association between one or more first features of a first bird's eye view (BEV) space around the first V2X-capable vehicle and one or more first V2X messages, wherein the one or more first features of the first BEV space is associated with the one or more first V2X messages based on one or more first objects detected in the one or more first features of the first BEV space being reported in the one or more first V2X messages, and wherein the one or more first messages further indicate a first set of BEV features representing the BEV space other than the one or more first features of the first BEV space associated with the one or more first V2X messages; and determine an occupancy of a global BEV space based, at least in part, on properties of the one or more first objects reported in the one or more first V2X messages.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIG. 3A is a top view of a vehicle employing an integrated radar-camera sensor behind the windshield, according to one or more aspects of the disclosure.

FIG. 3B illustrates an example on-board computer (OBC) architecture, according to one or more aspects of the disclosure.

FIGS. 4A, 4B, and 4C are simplified block diagrams of several sample aspects of components that may be employed in a user equipment (UE), a base station, and a network entity, respectively, and configured to support communications as taught herein.

FIG. 5 is a diagram illustrating an example intersection through which multiple connected vehicles are travelling, according to aspects of the disclosure.

FIG. 6 is a diagram illustrating a scenario where N connected vehicles each transmit a red-green-blue (RGB) image representing their respective bird's eye view (BEV) spaces, according to aspects of the disclosure.

FIG. 7 is a diagram illustrating an example of the disclosed hybrid vehicle-to-everything (V2X) and BEV feature signaling technique, according to aspects of the disclosure.

FIGS. 8 and 9 illustrate example methods of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to autonomous or semi-autonomous vehicles. Some aspects more specifically relate to vehicle-to-everything (V2X)-assisted bird's eye view (BEV) signaling. In some examples, a connected vehicle may transmit a BEV feature descriptor along with a V2X reference and/or object identifier of objects that are directly detected; other objects that are not associated with a V2X reference can be provided in the BEV transmission. This information (i.e., BEV feature descriptor, V2X reference, etc.) may be provided in a BEV grid (or partially in a BEV grid). This may include BEV grid coordinates with respect to the connected vehicle. This may also be expanded to other aspects of target object detection, such as velocity, trajectory, acceleration, object classification, object dynamics models, etc.

In some examples, a BEV grid is defined with respect to the connected vehicle, so a BEV grid would need to be aligned to the receiving vehicle or another connected vehicle's coordinate frame. This can be accomplished via a affine transformation matrix between two or more coordinate frames. This may also leverage global coordinate information to directly provide translation or a coarse translation.

In some examples, information from V2X messages may be used to extrapolate BEV features to minimize the periodicity of receiving this information. It may also be used to predict BEV grid occupancy at a future time. In some examples, vehicles may be configured to report V2X messages at a first periodicity and BEV features at a second periodicity (e.g., slower than the first periodicity). There may be a crowdsourcing aspect in terms of evaluating the prediction from the use of the V2X information for extrapolating BEV features. It may also indicate which specific V2X message types should be used.

Particular aspects of the subject matter described in this disclosure can be implemented to realize one or more of the following potential advantages. In some examples, by reporting V2X information instead of BEV features, the described techniques can be used to decrease signaling overhead when reporting BEV feature sets. This assists to enable the next stage of cooperative driving with high system efficiency, insofar as it minimizes each system's resources and allows edge infrastructure to improve cooperative driving and allow sharing with lesser capable vehicles.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device,” an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof.

A V-UE is a type of UE and may be any in-vehicle wireless communication device, such as a navigation system, a warning system, a heads-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

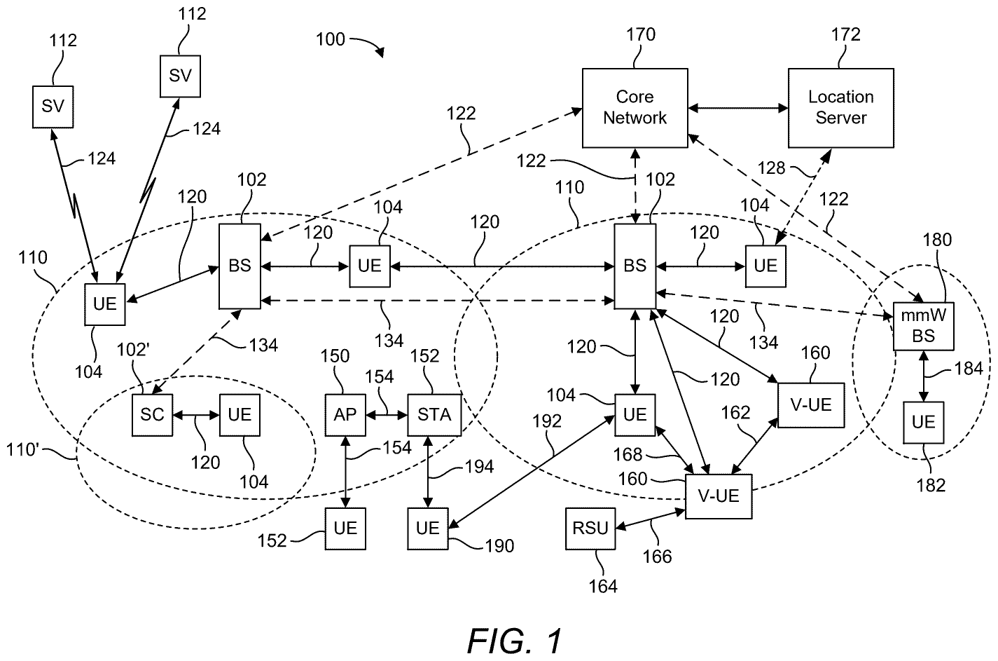

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHz. Other bands may be allocated in other countries. Thus, as a particular example, the medium of interest utilized by sidelinks 162, 166, 168 may correspond to at least a portion of the licensed ITS frequency band of sub-6 GHz. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHz (5.85-5.925 GHz) in the U.S. In Europe, IEEE 802.11p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHz.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards RSUs 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on. As another example, the D2D P2P links 192 and 194 may be sidelinks, as described above with reference to sidelinks 162, 166, and 168.

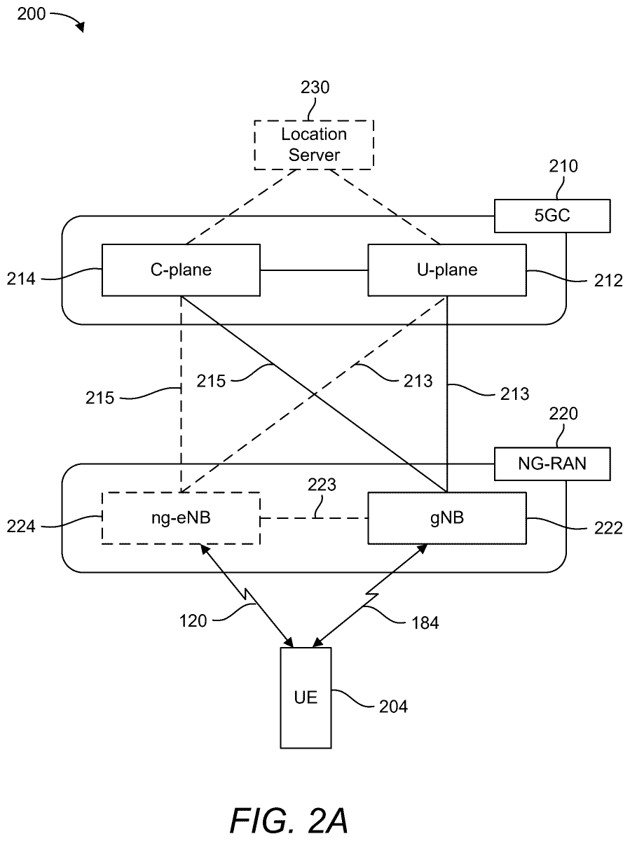

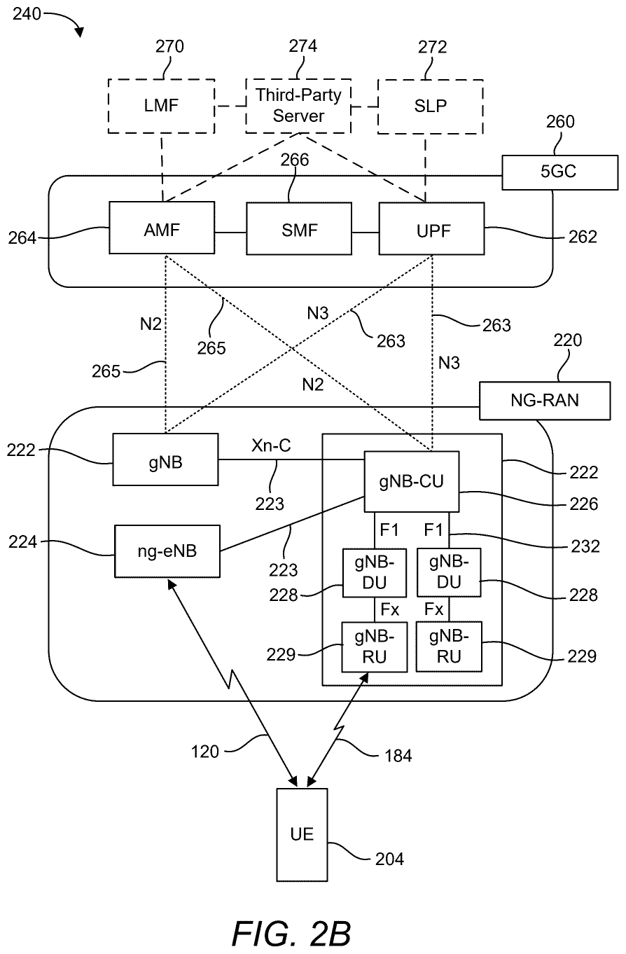

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Autonomous and semi-autonomous driving safety technologies use a combination of hardware (sensors, cameras, and radar) and software to help vehicles identify certain safety risks so they can warn the driver to act (in the case of an ADAS), or act themselves (in the case of an ADS), to avoid a crash. A vehicle outfitted with an ADAS or ADS includes one or more camera sensors mounted on the vehicle that capture images of the scene in front of the vehicle, and also possibly behind and to the sides of the vehicle. Radar systems may also be used to detect objects along the road of travel, and also possibly behind and to the sides of the vehicle. Radar systems utilize RF waves to determine the range, direction, speed, and/or altitude of the objects along the road. More specifically, a transmitter transmits pulses of RF waves that bounce off any object(s) in their path. The pulses reflected off the object(s) return a small part of the RF waves' energy to a receiver, which is typically located at the same location as the transmitter. The camera and radar are typically oriented to capture their respective versions of the same scene.

A processor, such as a digital signal processor (DSP), within the vehicle analyzes the captured camera images and radar frames and attempts to identify objects within the captured scene. Such objects may be other vehicles, pedestrians, road signs, objects within the road of travel, etc. The radar system provides reasonably accurate measurements of object distance and velocity in various weather conditions. However, radar systems typically have insufficient resolution to identify features of the detected objects. Camera sensors, however, typically do provide sufficient resolution to identify object features. The cues of object shapes and appearances extracted from the captured images may provide sufficient characteristics for classification of different objects. Given the complementary properties of the two sensors, data from the two sensors can be combined (referred to as “fusion”) in a single system for improved performance.

Modern motor vehicles are increasingly incorporating technology that helps drivers avoid drifting into adjacent lanes or making unsafe lane changes (e.g., lane departure warning (LDW)), or that warns drivers of other vehicles behind them when they are backing up, or that brakes automatically if a vehicle ahead of them stops or slows suddenly (e.g., forward collision warning (FCW)), among other things. The continuing evolution of automotive technology aims to deliver even greater safety benefits, and ultimately deliver automated driving systems (ADS) that can handle the entire task of driving without the need for user intervention.

There are six levels that have been defined to achieve full automation. At Level 0, the human driver does all the driving. At Level 1, an advanced driver assistance system (ADAS) on the vehicle can sometimes assist the human driver with either steering or braking/accelerating, but not both simultaneously. At Level 2, an ADAS on the vehicle can itself actually control both steering and braking/accelerating simultaneously under some circumstances. The human driver must continue to pay full attention at all times and perform the remainder of the driving tasks. At Level 3, an ADS on the vehicle can itself perform all aspects of the driving task under some circumstances. In those circumstances, the human driver must be ready to take back control at any time when the ADS requests the human driver to do so. In all other circumstances, the human driver performs the driving task. At Level 4, an ADS on the vehicle can itself perform all driving tasks and monitor the driving environment, essentially doing all of the driving, in certain circumstances. The human need not pay attention in those circumstances. At Level 5, an ADS on the vehicle can do all the driving in all circumstances. The human occupants are just passengers and need never be involved in driving.

To further enhance ADAS and ADS systems, especially at Level 3 and beyond, autonomous and semi-autonomous vehicles may utilize high definition (HD) map datasets, which contain significantly more detailed information and true-ground-absolute accuracy than those found in current conventional resources. Such HD maps may provide accuracy in the 7-10 cm absolute ranges, highly detailed inventories of all stationary physical assets related to roadways, such as road lanes, road edges, shoulders, dividers, traffic signals, signage, paint markings, poles, and other data useful for the safe navigation of roadways and intersections by autonomous/semi-autonomous vehicles. HD maps may also provide electronic horizon predictive awareness, which enables autonomous/semi-autonomous vehicles to know what lies ahead.

Note that an autonomous or semi-autonomous vehicle may be, but need not be, a V-UE. Likewise, a V-UE may be, but need not be, an autonomous or semi-autonomous vehicle. An autonomous or semi-autonomous vehicle is a vehicle outfitted with an ADAS or ADS. A V-UE is a vehicle with cellular connectivity to a 5G or other cellular network. An autonomous or semi-autonomous vehicle that uses, or is capable of using, cellular techniques for positioning and/or navigation is a V-UE.

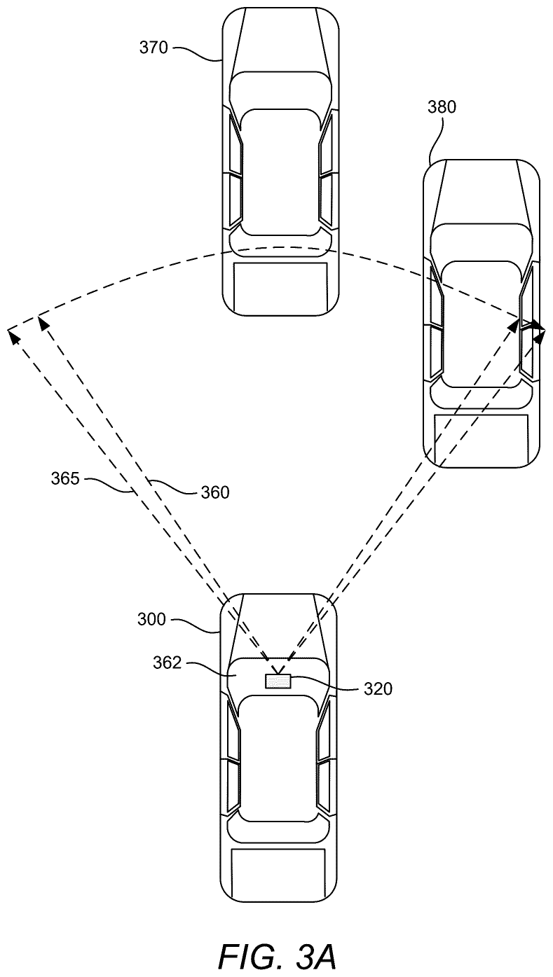

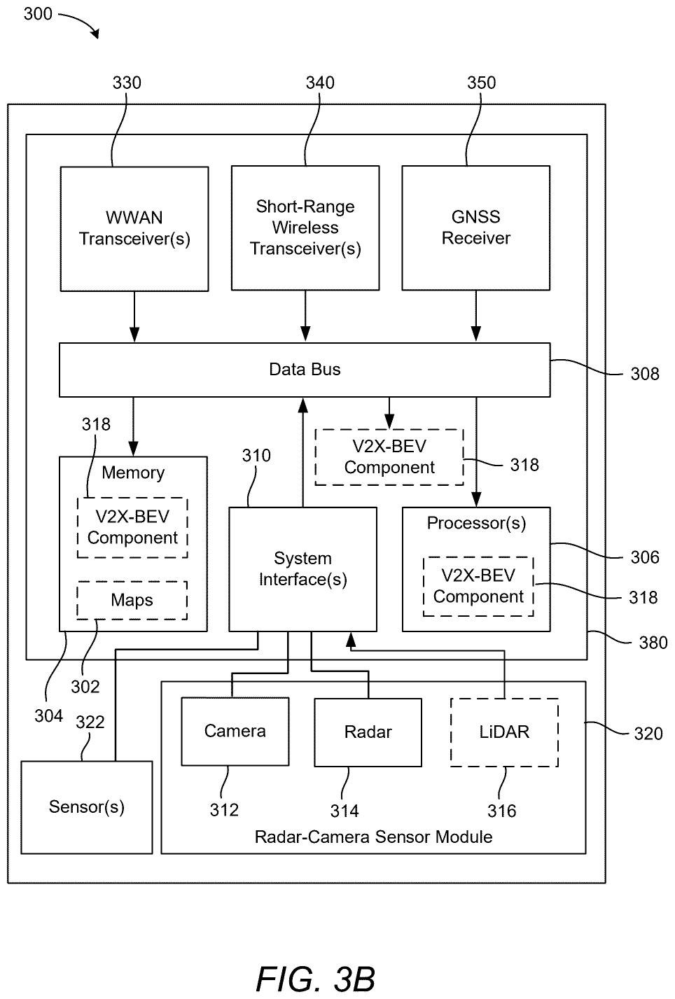

Referring now to FIG. 3A, a V2X-capable vehicle 300 (referred to as an “ego vehicle” or a “host vehicle”) is illustrated that includes a radar-camera sensor module 320 located in the interior compartment of the V2X-capable vehicle 300 behind the windshield 362. The radar-camera sensor module 320 includes a radar component configured to transmit radar signals through the windshield 362 in a horizontal coverage zone 365 (shown by dashed lines), and receive reflected radar signals that are reflected off of any objects within the horizontal coverage zone 365. The radar-camera sensor module 320 further includes a camera component for capturing images based on light waves that are seen and captured through the windshield 362 in a horizontal coverage zone 360 (shown by dashed lines).

Although FIG. 3A illustrates an example in which the radar component and the camera component are co-located components in a shared housing, as will be appreciated, they may be separately housed in different locations within the V2X-capable vehicle 300. For example, the camera may be located as shown in FIG. 3A, and the radar component may be located in the grill or front bumper of the V2X-capable vehicle 300. Additionally, although FIG. 3A illustrates the radar-camera sensor module 320 located behind the windshield 362, it may instead be located in a rooftop sensor array, or elsewhere. Further, although FIG. 3A illustrates only a single radar-camera sensor module 320, as will be appreciated, the V2X-capable vehicle 300 may have multiple radar-camera sensor modules 320 pointed in different directions (to the sides, the front, the rear, etc.). The various radar-camera sensor modules 320 may be under the “skin” of the vehicle (e.g., behind the windshield 362, door panels, bumpers, grills, etc.) or within a rooftop sensor array.

The radar-camera sensor module 320 may detect one or more (or none) objects relative to the V2X-capable vehicle 300. In the example of FIG. 3A, there are two objects, vehicles 370 and 380, within the horizontal coverage zones 360 and 365 that the radar-camera sensor module 320 can detect. The radar-camera sensor module 320 may estimate parameters (attributes) of the detected object(s), such as the position, range, direction, speed, size, classification (e.g., vehicle, pedestrian, road sign, etc.), and the like. The radar-camera sensor module 320 may be employed onboard the V2X-capable vehicle 300 for automotive safety applications, such as adaptive cruise control (ACC), FCW, collision mitigation or avoidance via autonomous braking, LDW, and the like.

Co-locating the camera and radar permits these components to share electronics and signal processing, and in particular, enables early radar-camera data fusion. For example, the radar and camera may be integrated onto a single board. A joint radar-camera alignment technique may be employed to align both the radar and the camera. However, co-location of the radar and camera is not required to practice the techniques described herein.

FIG. 3B illustrates an on-board computer (OBC) 380 of a V2X-capable vehicle 300, according to various aspects of the disclosure. In an aspect, the OBC 380 may be part of an ADAS or ADS. The OBC 380 may also be the V-UE of the V2X-capable vehicle 300. The OBC 380 includes a non-transitory computer-readable storage medium, i.e., memory 304, and one or more processors 306 in communication with the memory 304 via a data bus 308. The memory 304 includes one or more storage modules storing computer-readable instructions executable by the one or more processors 306 to perform the functions of the OBC 380 described herein. For example, the one or more processors 306 in conjunction with the memory 304 may implement the various operations described herein.

One or more radar-camera sensor modules 320 are coupled to the OBC 380 (only one is shown in FIG. 3B for simplicity). In some aspects, the radar-camera sensor module 320 includes at least one camera 312, at least one radar 314, and an optional light detection and ranging (lidar) sensor 316. The OBC 380 also includes one or more system interfaces 310 connecting the one or more processors 306, by way of the data bus 308, to the radar-camera sensor module 320 and, optionally, other vehicle sub-systems (not shown).

The OBC 380 also includes, at least in some cases, one or more wireless wide area network (WWAN) transceivers 330 configured to communicate via one or more wireless communication networks (not shown), such as an NR network, an LTE network, a Global System for Mobile communication (GSM) network, and/or the like. The one or more WWAN transceivers 330 may be connected to one or more antennas (not shown) for communicating with other network nodes, such as other V-UEs, pedestrian UEs, infrastructure access points, roadside units (RSUs), base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The one or more WWAN transceivers 330 may be variously configured for transmitting and encoding signals (e.g., messages, indications, information, and so on), and, conversely, for receiving and decoding signals (e.g., messages, indications, information, pilots, and so on) in accordance with the designated RAT.

The OBC 380 also includes, at least in some cases, one or more short-range wireless transceivers 340 (e.g., a Wi-Fi transceiver, a BLUETOOTH® transceiver, etc.). The one or more short-range wireless transceivers 340 may be connected to one or more antennas (not shown) for communicating with other network nodes, such as other V-UEs, pedestrian UEs, infrastructure access points, RSUs, etc., via at least one designated RAT (e.g., cV2X), IEEE 802.11p (also known as wireless access for vehicular environments (WAVE)), dedicated short-range communication (DSRC), etc.) over a wireless communication medium of interest. The one or more short-range wireless transceivers 340 may be variously configured for transmitting and encoding signals (e.g., messages, indications, information, and so on), and, conversely, for receiving and decoding signals (e.g., messages, indications, information, pilots, and so on) in accordance with the designated RAT.

As used herein, a “transceiver” may include a transmitter circuit, a receiver circuit, or a combination thereof, but need not provide both transmit and receive functionalities in all designs. For example, a low functionality receiver circuit may be employed in some designs to reduce costs when providing full communication is not necessary (e.g., a receiver chip or similar circuitry simply providing low-level sniffing).

The OBC 380 also includes, at least in some cases, a global navigation satellite system (GNSS) receiver 350. The GNSS receiver 350 may be connected to one or more antennas (not shown) for receiving satellite signals. The GNSS receiver 350 may comprise any suitable hardware and/or software for receiving and processing GNSS signals. The GNSS receiver 350 requests information and operations as appropriate from the other systems, and performs the calculations necessary to determine the vehicle's 300 position using measurements obtained by any suitable GNSS algorithm.

In an aspect, the OBC 380 may utilize the one or more WWAN transceivers 330 and/or the one or more short-range wireless transceivers 340 to download one or more maps 302 that can then be stored in memory 304 and used for vehicle navigation. Map(s) 302 may be one or more high definition (HD) maps, which may provide accuracy in the 7-10 cm absolute ranges, highly detailed inventories of all stationary physical assets related to roadways, such as road lanes, road edges, shoulders, dividers, traffic signals, signage, paint markings, poles, and other data useful for the safe navigation of roadways and intersections by the V2X-capable vehicle 300. Map(s) 302 may also provide electronic horizon predictive awareness, which enables the V2X-capable vehicle 300 to know what lies ahead.

The V2X-capable vehicle 300 may include one or more sensors 322 that may be coupled to the one or more processors 306 via the one or more system interfaces 310. The one or more sensors 322 may provide means for sensing or detecting information related to the state and/or environment of the V2X-capable vehicle 300, such as speed, heading (e.g., compass heading), headlight status, gas mileage, etc. By way of example, the one or more sensors 322 may include an odometer a speedometer, a tachometer, an accelerometer (e.g., a micro-electromechanical system-s (MEMS) device), a gyroscope, a geomagnetic sensor (e.g., a compass), an altimeter (e.g., a barometric pressure altimeter), etc. Although shown as located outside the OBC 380, some of these sensors 322 may be located on the OBC 380 and some may be located elsewhere in the V2X-capable vehicle 300.

The OBC 380 may further include a V2X-BEV component 318. The V2X-BEV component 318 may be a hardware circuit that is part of or coupled to the one or more processors 306 that, when executed, causes the OBC 380 to perform the functionality described herein. In other aspects, the V2X-BEV component 318 may be external to the one or more processors 306 (e.g., part of a positioning processing system, integrated with another processing system, etc.). Alternatively, the V2X-BEV component 318 may be one or more memory modules stored in the memory 304 that, when executed by the one or more processors 306 (or positioning processing system, another processing system, etc.), cause the OBC 380 to perform the functionality described herein. As a specific example, the V2X-BEV component 318 may comprise a plurality of positioning engines, a positioning engine aggregator, a sensor fusion module, and/or the like. FIG. 3B illustrates possible locations of the V2X-BEV component 318, which may be, for example, part of the memory 304, the one or more processors 306, or any combination thereof, or may be a standalone component.

In an aspect, the camera 312 may capture image frames (also referred to herein as camera frames) of the scene within the viewing area of the camera 312 (as illustrated in FIG. 3A as horizontal coverage zone 360) at some periodic rate. Likewise, the radar 314 may capture radar frames of the scene within the viewing area of the radar 314 (as illustrated in FIG. 3A as horizontal coverage zone 365) at some periodic rate. The periodic rates at which the camera 312 and the radar 314 capture their respective frames may be the same or different. Each camera and radar frame may be timestamped. Thus, where the periodic rates are different, the timestamps can be used to select simultaneously, or nearly simultaneously, captured camera and radar frames for further processing (e.g., fusion).

For convenience, the OBC380 is shown in FIG. 3B as including various components that may be configured according to the various examples described herein. It will be appreciated, however, that the illustrated components may have different functionality in different designs. In particular, various components in FIG. 3B are optional in alternative configurations and the various aspects include configurations that may vary due to design choice, costs, use of the device, or other considerations. For brevity, illustration of the various alternative configurations is not provided herein, but would be readily understandable to one skilled in the art.

The components of FIG. 3B may be implemented in various ways. In some implementations, the components of FIG. 3B may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 302 to 350 may be implemented by processor and memory component(s) of the OBC 380 (e.g., by execution of appropriate code and/or by appropriate configuration of processor components). For simplicity, various operations, acts, and/or functions are described herein as being performed “by a UE,” “by an OBC,” or “by a vehicle.” However, as will be appreciated, such operations, acts, and/or functions may actually be performed by specific components or combinations of components of the OBC 380, such as the one or more processors 306, the one or more transceivers 330 and 340, the memory 304, the V2X-BEV component 318, etc.

In an autonomous or semi-autonomous driving scenario, the ego vehicle needs to make various driving decisions, such when to change lanes (e.g., to avoid obstacles, move to an exit lane, etc.), where to merge into traffic, whether to pass another vehicle, and the like. These types of decisions are referred to as “driving policy” or “drive policy” and may be executed by the OBC 380 (e.g., the one or more processors 306, V2X-BEV component 318, memory 304, etc.) based on information from the radar-camera sensor module 320 and/or sensor(s) 322.

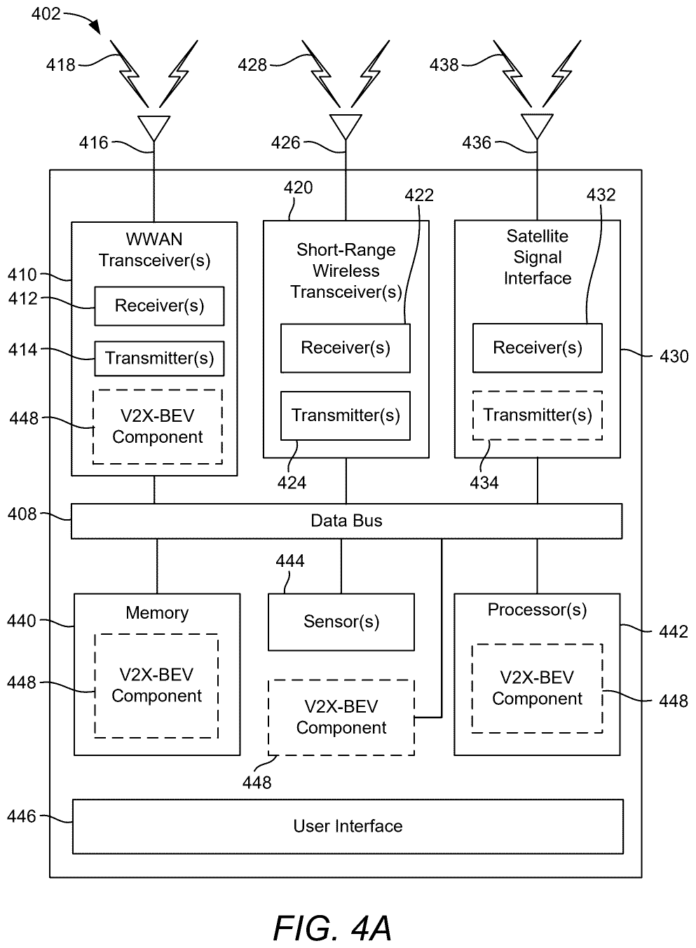

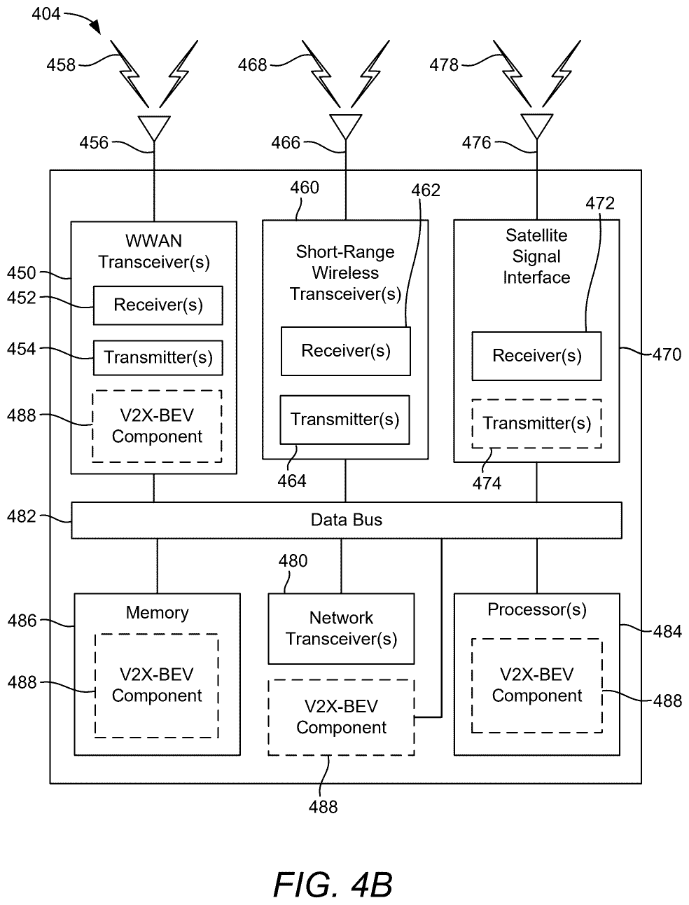

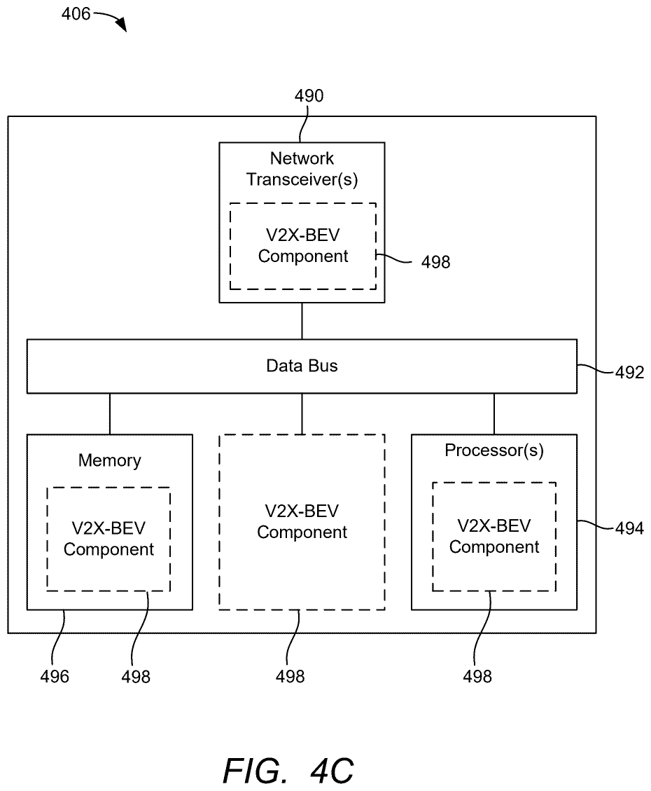

FIGS. 4A, 4B, and 4C illustrate several example components (represented by corresponding blocks) that may be incorporated into a UE 402 (which may correspond to any of the UEs described herein, such as V2X-capable vehicle 300, OBC 380, etc.), a base station 404 (which may correspond to any of the base stations or RSUs described herein), and a network entity 406 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 402 and the base station 404 each include one or more WWAN transceivers 410 and 450, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 410 and 450 may each be connected to one or more antennas 416 and 456, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 410 and 450 may be variously configured for transmitting and encoding signals 418 and 458 (e.g., messages, indications, information, and so on), respectively, and, conversely, for receiving and decoding signals 418 and 458 (e.g., messages, indications, information, pilots, and so on), respectively, in accordance with the designated RAT. Specifically, the WWAN transceivers 410 and 450 include one or more transmitters 414 and 454, respectively, for transmitting and encoding signals 418 and 458, respectively, and one or more receivers 412 and 452, respectively, for receiving and decoding signals 418 and 458, respectively.

The UE 402 and the base station 404 each also include, at least in some cases, one or more short-range wireless transceivers 420 and 460, respectively. The short-range wireless transceivers 420 and 460 may be connected to one or more antennas 426 and 466, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 420 and 460 may be variously configured for transmitting and encoding signals 428 and 468 (e.g., messages, indications, information, and so on), respectively, and, conversely, for receiving and decoding signals 428 and 468 (e.g., messages, indications, information, pilots, and so on), respectively, in accordance with the designated RAT. Specifically, the short-range wireless transceivers 420 and 460 include one or more transmitters 424 and 464, respectively, for transmitting and encoding signals 428 and 468, respectively, and one or more receivers 422 and 462, respectively, for receiving and decoding signals 428 and 468, respectively. As specific examples, the short-range wireless transceivers 420 and 460 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 402 and the base station 404 also include, at least in some cases, satellite signal interfaces 430 and 470, which each include one or more satellite signal receivers 432 (e.g., GNSS receiver 350) and 472, respectively, and may optionally include one or more satellite signal transmitters 434 and 474, respectively. In some cases, the base station 404 may be a terrestrial base station that may communicate with space vehicles (e.g., space vehicles 112) via the satellite signal interface 470. In other cases, the base station 404 may be a space vehicle (or other non-terrestrial entity) that uses the satellite signal interface 470 to communicate with terrestrial networks and/or other space vehicles.

The satellite signal receivers 432 and 472 may be connected to one or more antennas 436 and 476, respectively, and may provide means for receiving and/or measuring satellite positioning/communication signals 438 and 478, respectively. Where the satellite signal receiver(s) 432 and 472 are satellite positioning system receivers, the satellite positioning/communication signals 438 and 478 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 432 and 472 are non-terrestrial network (NTN) receivers, the satellite positioning/communication signals 438 and 478 may be communication signals (e.g., carrying control and/or user data) originating from a 5G network. The satellite signal receiver(s) 432 and 472 may comprise any suitable hardware and/or software for receiving and processing satellite positioning/communication signals 438 and 478, respectively. The satellite signal receiver(s) 432 and 472 may request information and operations as appropriate from the other systems, and, at least in some cases, perform calculations to determine locations of the UE 402 and the base station 404, respectively, using measurements obtained by any suitable satellite positioning system algorithm.

The optional satellite signal transmitter(s) 434 and 474, when present, may be connected to the one or more antennas 436 and 476, respectively, and may provide means for transmitting satellite positioning/communication signals 438 and 478, respectively. Where the satellite signal transmitter(s) 474 are satellite positioning system transmitters, the satellite positioning/communication signals 478 may be GPS signals, GLONASS® signals, Galileo signals, Beidou signals, NAVIC, QZSS signals, etc. Where the satellite signal transmitter(s) 434 and 474 are NTN transmitters, the satellite positioning/communication signals 438 and 478 may be communication signals (e.g., carrying control and/or user data) originating from a 5G network. The satellite signal transmitter(s) 434 and 474 may comprise any suitable hardware and/or software for transmitting satellite positioning/communication signals 438 and 478, respectively. The satellite signal transmitter(s) 434 and 474 may request information and operations as appropriate from the other systems.

The base station 404 and the network entity 406 each include one or more network transceivers 480 and 490, respectively, providing means for communicating (e.g., means for transmitting, means for receiving, etc.) with other network entities (e.g., other base stations 404, other network entities 406). For example, the base station 404 may employ the one or more network transceivers 480 to communicate with other base stations 404 or network entities 406 over one or more wired or wireless backhaul links. As another example, the network entity 406 may employ the one or more network transceivers 490 to communicate with one or more base station 404 over one or more wired or wireless backhaul links, or with other network entities 406 over one or more wired or wireless core network interfaces.

A transceiver may be configured to communicate over a wired or wireless link. A transceiver (whether a wired transceiver or a wireless transceiver) includes transmitter circuitry (e.g., transmitters 414, 424, 454, 464) and receiver circuitry (e.g., receivers 412, 422, 452, 462). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 480 and 490 in some implementations) may be coupled to one or more wired network interface ports. Wireless transmitter circuitry (e.g., transmitters 414, 424, 454, 464) may include or be coupled to a plurality of antennas (e.g., antennas 416, 426, 456, 466), such as an antenna array, that permits the respective apparatus (e.g., UE 402, base station 404) to perform transmit “beamforming,” as described herein. Similarly, wireless receiver circuitry (e.g., receivers 412, 422, 452, 462) may include or be coupled to a plurality of antennas (e.g., antennas 416, 426, 456, 466), such as an antenna array, that permits the respective apparatus (e.g., UE 402, base station 404) to perform receive beamforming, as described herein. In an aspect, the transmitter circuitry and receiver circuitry may share the same plurality of antennas (e.g., antennas 416, 426, 456, 466), such that the respective apparatus can only receive or transmit at a given time, not both at the same time. A wireless transceiver (e.g., WWAN transceivers 410 and 450, short-range wireless transceivers 420 and 460) may also include a network listen module (NLM) or the like for performing various measurements.

As used herein, the various wireless transceivers (e.g., transceivers 410, 420, 450, and 460, and network transceivers 480 and 490 in some implementations) and wired transceivers (e.g., network transceivers 480 and 490 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 402) and a base station (e.g., base station 404) will generally relate to signaling via a wireless transceiver.

The UE 402, the base station 404, and the network entity 406 also include other components that may be used in conjunction with the operations as disclosed herein. The UE 402, the base station 404, and the network entity 406 include one or more processors 442, 484, and 494, respectively, for providing functionality relating to, for example, wireless communication, and for providing other processing functionality. The processors 442, 484, and 494 may therefore provide means for processing, such as means for determining, means for calculating, means for receiving, means for transmitting, means for indicating, etc. In an aspect, the processors 442, 484, and 494 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 402, the base station 404, and the network entity 406 include memory circuitry implementing memories 440, 486, and 496 (e.g., each including a memory device), respectively, for maintaining information (e.g., information indicative of reserved resources, thresholds, parameters, and so on). The memories 440, 486, and 496 may therefore provide means for storing, means for retrieving, means for maintaining, etc. In some cases, the UE 402, the base station 404, and the network entity 406 may include V2X-BEV component 448 (which may correspond to V2X-BEV component 318), 488, and 498, respectively. The V2X-BEV component 448, 488, and 498 may be hardware circuits that are part of or coupled to the processors 442, 484, and 494, respectively, that, when executed, cause the UE 402, the base station 404, and the network entity 406 to perform the functionality described herein. In other aspects, the V2X-BEV component 448, 488, and 498 may be external to the processors 442, 484, and 494 (e.g., part of a modem processing system, integrated with another processing system, etc.). Alternatively, the V2X-BEV component 448, 488, and 498 may be memory modules stored in the memories 440, 486, and 496, respectively, that, when executed by the processors 442, 484, and 494 (or a modem processing system, another processing system, etc.), cause the UE 402, the base station 404, and the network entity 406 to perform the functionality described herein. FIG. 4A illustrates possible locations of the V2X-BEV component 448, which may be, for example, part of the one or more WWAN transceivers 410, the memory 440, the one or more processors 442, or any combination thereof, or may be a standalone component. FIG. 4B illustrates possible locations of the V2X-BEV component 488, which may be, for example, part of the one or more WWAN transceivers 450, the memory 486, the one or more processors 484, or any combination thereof, or may be a standalone component. FIG. 4C illustrates possible locations of the V2X-BEV component 498, which may be, for example, part of the one or more network transceivers 490, the memory 496, the one or more processors 494, or any combination thereof, or may be a standalone component.

The UE 402 may include one or more sensors 444 coupled to the one or more processors 442 to provide means for sensing or detecting movement and/or orientation information that is independent of motion data derived from signals received by the one or more WWAN transceivers 410, the one or more short-range wireless transceivers 420, and/or the satellite signal interface 430. By way of example, the sensor(s) 444 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 444 may include a plurality of different types of devices and combine their outputs in order to provide motion information. For example, the sensor(s) 444 may use a combination of a multi-axis accelerometer and orientation sensors to provide the ability to compute positions in two-dimensional (2D) and/or three-dimensional (3D) coordinate systems.

In addition, the UE 402 includes a user interface 446 providing means for providing indications (e.g., audible and/or visual indications) to a user and/or for receiving user input (e.g., upon user actuation of a sensing device such a keypad, a touch screen, a microphone, and so on). Although not shown, the base station 404 and the network entity 406 may also include user interfaces.

Referring to the one or more processors 484 in more detail, in the downlink, IP packets from the network entity 406 may be provided to the processor 484. The one or more processors 484 may implement functionality for an RRC layer, a packet data convergence protocol (PDCP) layer, a radio link control (RLC) layer, and a medium access control (MAC) layer. The one or more processors 484 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 454 and the receiver 452 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 454 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 402. Each spatial stream may then be provided to one or more different antennas 456. The transmitter 454 may modulate an RF carrier with a respective spatial stream for transmission.

At the UE 402, the receiver 412 receives a signal through its respective antenna(s) 416. The receiver 412 recovers information modulated onto an RF carrier and provides the information to the one or more processors 442. The transmitter 414 and the receiver 412 implement Layer-1 functionality associated with various signal processing functions. The receiver 412 may perform spatial processing on the information to recover any spatial streams destined for the UE 402. If multiple spatial streams are destined for the UE 402, they may be combined by the receiver 412 into a single OFDM symbol stream. The receiver 412 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 404. These soft decisions may be based on channel estimates computed by a channel estimator. The soft decisions are then decoded and de-interleaved to recover the data and control signals that were originally transmitted by the base station 404 on the physical channel. The data and control signals are then provided to the one or more processors 442, which implements Layer-3 (L3) and Layer-2 (L2) functionality.

In the downlink, the one or more processors 442 provides demultiplexing between transport and logical channels, packet reassembly, deciphering, header decompression, and control signal processing to recover IP packets from the core network. The one or more processors 442 are also responsible for error detection.

Similar to the functionality described in connection with the downlink transmission by the base station 404, the one or more processors 442 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 404 may be used by the transmitter 414 to select the appropriate coding and modulation schemes, and to facilitate spatial processing. The spatial streams generated by the transmitter 414 may be provided to different antenna(s) 416. The transmitter 414 may modulate an RF carrier with a respective spatial stream for transmission.

The uplink transmission is processed at the base station 404 in a manner similar to that described in connection with the receiver function at the UE 402. The receiver 452 receives a signal through its respective antenna(s) 456. The receiver 452 recovers information modulated onto an RF carrier and provides the information to the one or more processors 484.

In the uplink, the one or more processors 484 provides demultiplexing between transport and logical channels, packet reassembly, deciphering, header decompression, control signal processing to recover IP packets from the UE 402. IP packets from the one or more processors 484 may be provided to the core network. The one or more processors 484 are also responsible for error detection.

For convenience, the UE 402, the base station 404, and/or the network entity 406 are shown in FIGS. 4A, 4B, and 4C as including various components that may be configured according to the various examples described herein. It will be appreciated, however, that the illustrated components may have different functionality in different designs. In particular, various components in FIGS. 4A to 4C are optional in alternative configurations and the various aspects include configurations that may vary due to design choice, costs, use of the device, or other considerations. For example, in case of FIG. 4A, a particular implementation of UE 402 may omit the WWAN transceiver(s) 410 (e.g., a wearable device or tablet computer or personal computer (PC) or laptop may have Wi-Fi and/or BLUETOOTH® capability without cellular capability), or may omit the short-range wireless transceiver(s) 420 (e.g., cellular-only, etc.), or may omit the satellite signal interface 430, or may omit the sensor(s) 444, and so on. In another example, in case of FIG. 4B, a particular implementation of the base station 404 may omit the WWAN transceiver(s) 450 (e.g., a Wi-Fi “hotspot” access point without cellular capability), or may omit the short-range wireless transceiver(s) 460 (e.g., cellular-only, etc.), or may omit the satellite signal interface 470, and so on. For brevity, illustration of the various alternative configurations is not provided herein, but would be readily understandable to one skilled in the art.

The various components of the UE 402, the base station 404, and the network entity 406 may be communicatively coupled to each other over data buses 408, 482, and 492, respectively. In an aspect, the data buses 408, 482, and 492 may form, or be part of, a communication interface of the UE 402, the base station 404, and the network entity 406, respectively. For example, where different logical entities are embodied in the same device (e.g., gNB and location server functionality incorporated into the same base station 404), the data buses 408, 482, and 492 may provide communication between them.

The components of FIGS. 4A, 4B, and 4C may be implemented in various ways. In some implementations, the components of FIGS. 4A, 4B, and 4C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 410 to 446 may be implemented by processor and memory component(s) of the UE 402 (e.g., by execution of appropriate code and/or by appropriate configuration of processor components). Similarly, some or all of the functionality represented by blocks 450 to 488 may be implemented by processor and memory component(s) of the base station 404 (e.g., by execution of appropriate code and/or by appropriate configuration of processor components). Also, some or all of the functionality represented by blocks 490 to 498 may be implemented by processor and memory component(s) of the network entity 406 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 402, base station 404, network entity 406, etc., such as the processors 442, 484, 494, the transceivers 410, 420, 450, and 460, the memories 440, 486, and 496, the V2X-BEV component 448, 488, and 498, etc.

In some designs, the network entity 406 may be implemented as a core network component. In other designs, the network entity 406 may be distinct from a network operator or operation of the cellular network infrastructure (e.g., NG RAN 220 and/or 5GC 210/260). For example, the network entity 406 may be a component of a private network that may be configured to communicate with the UE 402 via the base station 404 or independently from the base station 404 (e.g., over a non-cellular communication link, such as Wi-Fi).

Autonomous driving requires an accurate representation of the environment around the autonomous or semi-autonomous vehicle (also referred to as an “ego vehicle,” a “connected vehicle,” or a “V2X-capable vehicle”). The “environment” includes static elements, such as the road layout (e.g., lane boundaries) and lane structures (e.g., traffic lights), and dynamic elements, such as other vehicles, pedestrians, and other types of road users. The static elements can be determined from high-definition (HD) maps containing lane level information.

To detect dynamic elements in the environment (e.g., other vehicles), or in places where there is no map support, an ego vehicle can employ birds-eye-view (BEV) sensing. BEV sensing is based on images captured by one or more cameras of the ego vehicle in different directions at the same time. These images can be stitched together to determine a set of BEV features representing the BEV space around the ego vehicle. Objects (e.g., lane boundaries, other vehicles, etc.) can then be detected based on the BEV feature set (or simply “BEV”). The BEV space corresponds to the two- or three-dimensional environment around the ego vehicle, and may correspond to, be represented by, be equivalent to, or be mapped to a corresponding BEV grid or red-green-blue (RGB) image/matrix/grid on a two-dimensional plane.

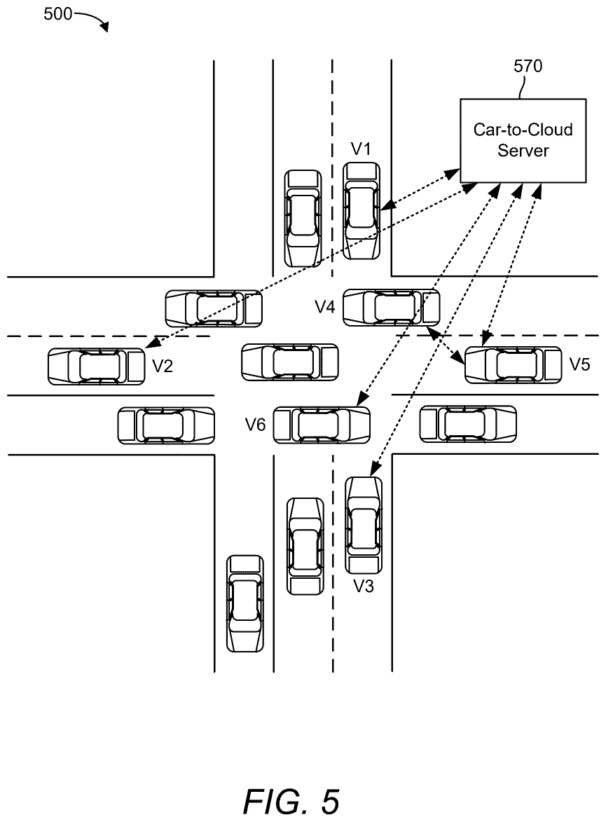

FIG. 5 is a diagram 500 illustrating an example intersection through which multiple connected vehicles are travelling, according to aspects of the disclosure. In the example of FIG. 5, six connected vehicles (labeled “V1” to “V6”) are connected to a car-to-cloud (C2C) server 570 via a wireless Uu air interface (e.g., NR, LTE etc.,). The C2C server 570 may be a network server (e.g., a location server or other network server), an over-the-top (OTT) server, or other third-party server. In addition to the respective Uu interface connections, the vehicles may also be connected to each other via sidelink connections, as shown by the connection between vehicles V4 and V5.

Each connected vehicle constructs a BEV feature set based on its local field-of-view (FoV) using one or more cameras with which the vehicle is equipped. The vehicles then report their respective local BEV feature sets to the C2C server 570. The C2C server 570 then attempts to construct a global BEV feature set based on the local BEV feature sets from the connected vehicles V1 to V6.

The local BEV obtained by a connected vehicle Vᵢ using its sensors may be denoted LBEV(i), and the global BEV generated by the C2C server 570 by crowdsourcing information from the connected vehicles V1 to V6 may be denoted GBEV. The C2C server 570 may use the GBEV to enhance the LBEV(i) at each connected vehicle Vᵢ. For example, a vehicle Vᵢ may have some occluded regions that cannot be perceived locally in its LBEV(i). To address this potentiality, the C2C server 570 may provide additional BEV information for those occluded regions (denoted A(i)), such that, LBEV(t)=LBEV(i)+A(i) is an enhanced version of vehicle Vᵢ's BEV space.

Note that to help collect and share sensor messages between the connected vehicles V1 to V6 and the C2C server 570, sensor data sharing messages (SDSMs) and collective perception messages (CPMs) have been defined.

Cooperative (global) BEV involves sharing and collecting BEV-related features to enable the C2C server 570 and/or a connected vehicle to construct a local or global BEV. For conventional BEV feature transmission, a connected vehicle transmits a RGB image at every reporting occasion. The RGB image represents a matrix/grid of probabilities, where each matrix/grid element (i.e., pixel in the RGB image) represents the probability of an object detection in the area that that matrix/grid element represents (e.g., 0.5 meters squared (m²)) in the BEV. The area that a matrix/grid element represents is defined by the resolution of the BEV. As such, the size of the transmitted image is proportional to the resolution of each matrix/grid element in the BEV. The higher the resolution, the higher the size of the matrix/grid (image) transmitted.

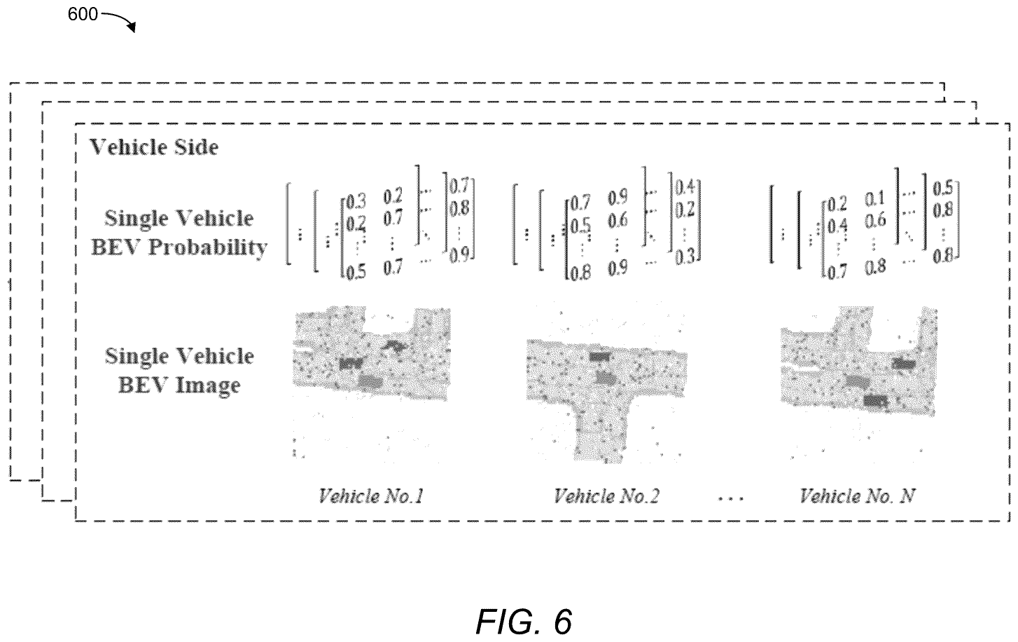

FIG. 6 is a diagram 600 illustrating a scenario where N connected vehicles each transmit an RGB image representing their respective BEV spaces, according to aspects of the disclosure. The C2C server 570, or another connected vehicle, may combine these separate BEVs into a global (cooperative) BEV.

As will be appreciated, transmitting a full RGB image is a significant overhead that each vehicle incurs in terms of spectral efficiency and the amount of information that is reconstructed at the receiver (e.g., the C2C server 570 or another connected vehicle). For example, the overhead in transmitting a 512×512×3 RGB image (where 512 is the height and width of the image and 3 is for R, G, and B) every 0.5 seconds is significant. To reduce this overhead, the present disclosure provides techniques to leverage V2X to describe BEV features.

The present disclosure provides a cooperative sensing approach that significantly reduces signaling overhead for the construction of a global BEV among connected vehicles. The disclosed techniques leverage V2X communications to reference detected object locations in local BEV transmissions, thereby avoiding duplication of sensor data reporting. By coordinating local BEV views across multiple vehicles using V2X message identifiers, the present disclosure enables seamless cloud-based reconstruction of a global BEV with minimized spectral usage.

As a first technique described herein, a connected vehicle can reference a V2X message when transmitting the BEV feature set. More specifically, instead of transmitting the BEV features corresponding to the entire RGB image/matrix/grid, the vehicle can indicate that certain regions in the BEV feature set correspond to a V2X message identifier (ID) and an object ID.

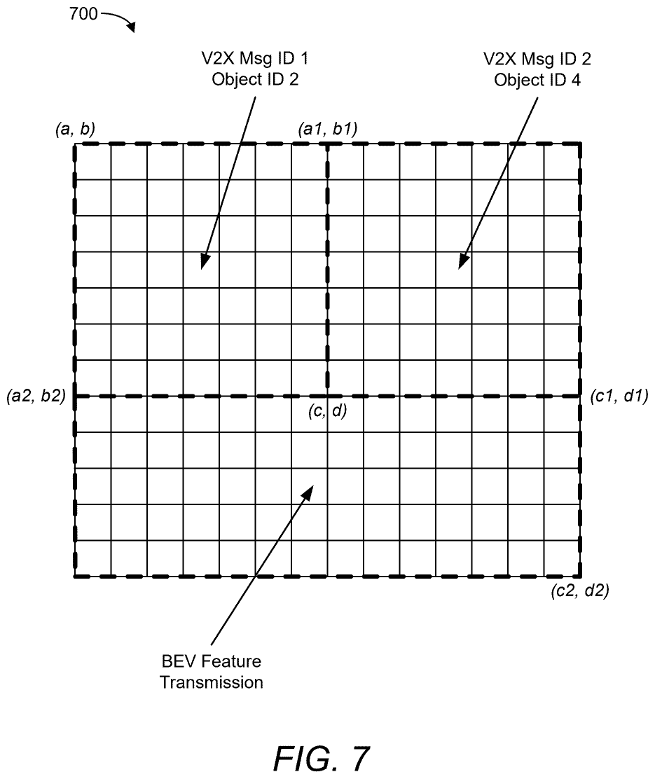

FIG. 7 is a diagram 700 illustrating an example of the disclosed hybrid V2X and BEV feature signaling technique, according to aspects of the disclosure. In the example of FIG. 7, the RGB image/matrix/grid representing the BEV feature set is 12×14 pixels, but as will be appreciated, this is a simplification for the ease of illustration, and the RGB image may be 512×512.

In the example of FIG. 7, the connected vehicle transmits at least two V2X messages (e.g., SDSM/CPM). The first V2X message is denoted “V2X Msg ID 1” and includes an object ID denoted “Object ID 2.” The first V2X message may be, for example, an SDSM. The second V2X message is denoted “V2X Msg ID 2” and includes an object ID denoted “Object ID 4.” The second V2X message may be, for example, a CPM. These V2X messages may be transmitted by default as part of V2X transmission by the vehicle. For any vehicle, one or more V2X messages may be generated by the vehicle based on object detection, or may be received from one or more other V2X-capable vehicles including object detection information.

In the example of FIG. 7, the connected vehicle detects a first object in the region of the RGB image from (a, b) to (c, d) (where (a, b) denotes the left top corner of the BEV bounding box around the detected object and (c, d) denotes the right bottom corner) and a second object in the region of the RGB image from (a1, b1) to (c1, d1) (where (a1, b1) denotes the left top corner of the BEV bounding box around the detected object and (c1, d1) denotes the right bottom corner). For the region from (a, b) to (c, d), the first V2X message transmitted by the vehicle includes information about that object, including an object identifier (Object ID 2) for the detected object. Likewise, for the region from (a1, b1) to (c1, d1), the second V2X message transmitted by the vehicle includes information about that object, including an object identifier (Object ID 4) for the detected object.

Thus, for the region of the RGB image from (a, b) to (c, d), instead of reporting the matrix elements/pixels for that region, the vehicle simply reports the identifier of the V2X message that includes the object identifier of the object detected in that region (here, V2X Msg ID 1 and Object ID 2). Likewise, for the region of the RGB image from (a1, b1) to (c1, d1), instead of reporting the matrix elements/pixels for that region, the vehicle simply reports the identifier of the V2X message that includes the object identifier of the object detected in that region (here, V2X Msg ID 2 and Object ID 4). That is, V2X-assisted BEV feature transmission is performed by referencing coordinates in the BEV matrix that map to a V2X message ID and corresponding object ID.

For the region of the RGB image where no objects are detected, or no objects associated with a V2X message are detected, the vehicle reports the matrix elements/pixels for that region. In the example of FIG. 7, the vehicle reports the matrix elements/pixels for the region from (a2, b2) to (c2, d2). Note that a connected vehicle transmits V2X messages only for objects that it has detected with sufficiently high certainty. For those objects that are ambiguous (i.e., have not been detected with sufficient certainty), the vehicle resorts to BEV transmission.

Thus, the V2X-assisted signaling scheme described herein may generally follow the following format. For coordinates in the BEV space that correspond to a V2X message, the connected vehicle may specify the best bounding box in the mapped BEV image. In some cases, the object referenced in the V2X message may not be perfectly aligned with the bounding box in the RGB image/matrix/grid, but instead, may simply provide an approximation of the bounding box coordinates. For coordinates in the BEV space that do not correspond to a V2X message, the connected vehicle provides the conventional BEV feature transmission.

As will be appreciated, based on the foregoing signaling scheme, the recipient (e.g., another connected vehicle, the C2C server 570) is informed of the regions where it needs to use, or to look for, V2X messages for the object detections and where it cannot.

The present disclosure further provides techniques for matching and aligning object detections across vehicle perspectives to maximize reuse of V2X messages. This technique utilizes an affine transformation matrix to map object bounding boxes between different vehicle coordinate frames.

As an example, let BBi=(x11, y11, x12, y12) be the bounding box of an object i as detected by a connected vehicle Vᵢ and within the coordinate frame of the connected vehicle V1, where (x11, y11) and (x12, y12) are the top-left and bottom-right corner points of the bounding box. Similarly, let BBj=(x21, y21, x22, y22) be the bounding box of the same object i as detected by another connected vehicle V2 and within the coordinate frame of the connected vehicle V2, where (x21, y21) and (x22, y22) are the top-left and bottom-right corner points of the bounding box. The technique computes an affine transformation matrix T that maps between the two coordinate frames.

The affine transformation matrix T=[a b c d e f], where a, b, c, d, e, and f are the transformation parameters (scale, rotation, translation, etc.). An optimization problem is formulated to minimize the alignment error between the mapped and actual bounding boxes, as:

$${min}_{T {\sum }_{i} \vert T \cdot {BB}_{i} - {BB}_{j} \vert}$$

The above equation is subject to: |a|<s, |d|<s, |b|<r, |e|<r, where s is the scale limit and r is the rotation limit. The affine transformation matrix T is estimated using a least squares optimization.

Once aligned, if |T·BBᵢ−BBⱼ| is less than a threshold, the same V2X message can be reused for both object detections. Otherwise, a new V2X message is generated. This allows object detections to be correlated despite differences in vehicle poses and perspectives, thereby improving reuse of cooperative sensing data.

The foregoing technique may be expanded to leverage additional V2X attributes beyond simply object IDs and locations, such as velocity vectors, trajectory/path history, acceleration and/or jerks, object classification, and the object dynamics model. With respect to velocity vectors, rather than re-transmitting raw sensor velocity data in each new V2X message, connected vehicles may reference the identifier of the last V2X message in which the velocity vector was transmitted. This V2X message (i.e., the last V2X message containing the velocity vector) may contain the object ID, the current velocity vector, and a timestamp. Recipients may then predict future positions of the object based on elapsed time.

With respect to trajectory/path history, connected vehicles may maintain a short trajectory history for each detected object (e.g., the most recent 10 waypoints). New waypoints are only transmitted if the trajectory/path diverges from the predicted trajectory/path based on the prior waypoints by more than a threshold.

With respect to acceleration/jerks, instead of constantly updating the velocity, connected vehicles may reference the last V2X message containing the object ID and acceleration and/or jerks applied since that message. Recipients use this to refine predicted trajectories over short time horizons.

With respect to object classification, a single V2X message containing object type (e.g., car, pedestrian, cyclist, etc.) may be reused until the object type changes. This avoids re-specifying the object class with every update.

With respect to the object dynamics model, connected vehicles may reference a specific dynamics model ID learned from past V2X data about an object's motion patterns (e.g., aggressive driver, cautious driver). This compactly conveys behavior.

The foregoing techniques may involve standardizing additional V2X message types and attributes to efficiently share higher level semantic descriptions about objects rather than just their instantaneous location/velocity. This further reduces transmission overhead through temporal/behavioral referencing.

With further reference to constructing the global BEV feature set/grid occupancy using V2X messages, V2X messages (e.g., SDSM/CPM) have clear definitions of objects, including their speed and heading. The receiving entity (e.g., C2C server 570 or another connected vehicle) can use this V2X side information (from the V2X messages) in extrapolating BEV features along time and space.

As an example, the speed/heading reported in a V2X message at time t may be used to predict the BEV grid occupancy at a future time (t+Δt) deterministically. As another example, an object as reported in a V2X message (e.g., a vehicle make and/or model) by a first connected vehicle may enable the BEV features reported by a second vehicle deterministically. For example, if a first vehicle reports a V2X message indicating the presence of a particular object in a specific BEV region/matrix element(s), it enables the receiving entity to infer BEV features reported by a second vehicle in that specific BEV region/matrix element(s). This enhances the inferencing ability of the reported BEV features.

With respect to signaling overhead reduction, the presence of an object along with its motion state (e.g., acceleration, speed, etc.) as received in a V2X message may be used to predict future occupancy deterministically. This leads to other vehicles not needing to report BEV features for those regions in the BEV matrix that reference V2X messages.

In some cases, the receiving entity (e.g., C2C server 570 or another connected vehicle) may configure the vehicles to report V2X messages, BEV feature sets, or hybrid V2X-BEV messages in one or more of the following ways. As a first option, the C2C server 570 may configure a connected vehicle to use V2X reporting for one or more first regions of the vehicle's BEV grid and BEV feature reporting for one or more second regions of the vehicle's BEV grid. For example, referring to FIG. 7, the C2C server 570 may configure the connected vehicle to utilize V2X message reporting for the region [(a, b), (c, d)], and to utilize BEV feature transmission for the region [(a2, b2), (c2,d2)]. The connected vehicle may then transmit SDSM V2X messages for objects detected in the first region and a BEV feature set (e.g., an RGB image) for the second region (regardless of whether any objects are detected).

In some cases, the C2C server 570 may maintain a map associating regions to reporting types (V2X versus BEV). The C2C server 570 may also evaluate the performance of V2X reporting versus BEV feature reporting separately for distinct regions. This allows for testing the efficacy of different reporting schemes for localized areas (e.g., non-overlapping regions) of the BEV grid in a controlled manner.

As a second option for configuring a connected vehicle to report V2X messages, BEV feature sets, or hybrid V2X-BEV messages, the C2C server 570 may configure a connected vehicle to report a first type of V2X message (e.g., SDSM) for a first object ID in a first region of the BEV grid, while configuring the vehicle to report a second type of V2X message (e.g., basic safety message (BSM)) for a second object ID in a second region of the BEV grid. The first region and the second region may be the same region of the BEV grid or different regions thereof. The first object and the second object may be the same object or different objects.

In this case, the C2C server 570 maintains a map of object IDs and their locations in regions of the BEV grid. The C2C server 570 may assign different V2X message types (SDSM, BSM, etc.) to each object-region pair. For example, the C2C server 570 may send a message configuring a connected vehicle to use SDSM V2X messages for a first object detected in a first region and to use BSM V2X messages for a second object in a second region. In response, the connected vehicle transmits the V2X messages with the configured V2X message types for each object-region pair. This allows for testing the performance of different V2X message types for varied scenarios (e.g., for distinct objects and locations in the BEV grid). For example, the C2C server 570 can evaluate the effects of message type on reception, latency, etc. Then, the most effective type can be selected dynamically.

As a third option for configuring a connected vehicle to report V2X messages, BEV feature sets, or hybrid V2X-BEV messages, the C2C server 570 may configure a connected vehicle to report a first type of V2X message for a first region of the BEV grid including a first object ID for first time period, and configure the vehicle to report a second type of V2X message for a second object for a second time period in a second region of the BEV grid. The first region and the second region may be the same region of the BEV grid or different regions thereof. The first object and the second object may be the same object or different objects.

In this case, the C2C server 570 may maintain a map of object IDs, locations/regions in the BEV grid, and time periods. The C2C server 570 may dynamically assign different V2X message types (e.g., CPM, decentralized environmental notification messages (DENM)) to each object-region-time period combination. The C2C server 570 may provide a configuration to connected vehicles specifying which message type to use for each combination.

For example, during a first time period, a connected vehicle may be configured to transmit CPM messages for a first object in a first region of the BEV grid. During a second time period, the vehicle may be configured to transmit DENM messages for a second object in a second region.

In this case, message types can be varied over time to test different encoding schemes. The C2C server 570 can then evaluate the efficacy of each scheme based on the received messages. The configuration may then be updated periodically based on the performance and/or other conditions. This enables the testing of different V2X standards efficiently and dynamically adapting based on network/environment changes.

As a fourth option for configuring a connected vehicle to report V2X messages, BEV feature sets, or hybrid V2X-BEV messages, the C2C server 570 may configure a connected vehicle to report only BEV transmissions in order to obtain fine BEV features for a particular BEV grid or grid region not reported by other vehicles.

In this case, the C2C server 570 may maintain a mapping of which connected vehicles are reporting which regions of the global BEV grid via V2X messages. The C2C server 570 may identify any regions not covered by V2X messages from other vehicles (e.g., due to limited sensing ranges). The C2C server 570 may then configure one or more connected vehicles to transmit BEV feature sets for only the uncovered regions. In response, the configured vehicle(s) transmit BEV feature sets for those specified regions while omitting already-covered areas reported by other vehicles via V2X messages. The C2C server 570 may then stitch together BEV data from V2X messages and direct BEV feature set transmissions to build a complete global BEV.

Some of the benefits of this approach is that the network can obtain fine-grained BEV data only where needed to fill gaps, thereby reducing signaling overhead. It also leverages both V2X messages and direct BEV transmission intelligently, minimizes overall network usage and latency for global BEV reconstruction, and the dynamic configuration allows for the adaptation to changing vehicle distributions.

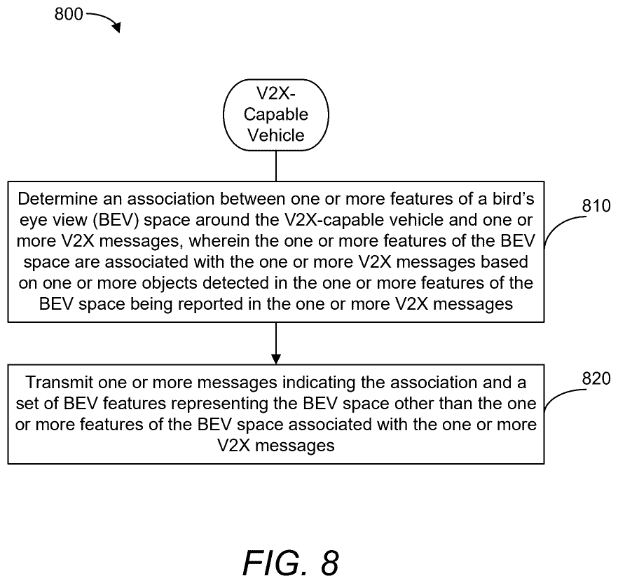

FIG. 8 illustrates an example method 800 of wireless communication, according to aspects of the disclosure. In an aspect, method 800 may be performed by a V2X-capable vehicle (e.g., any of the connected vehicles described herein).

At operation 810, the V2X-capable vehicle may determine an association between one or more features of a BEV space around the V2X-capable vehicle and one or more V2X messages, where the one or more features of the BEV space are associated with the one or more V2X messages based on one or more objects detected in the one or more features of the BEV space being reported in the one or more V2X messages.

In an aspect, operation 810 may be performed by the one or more WWAN transceivers 330, the one or more short-range wireless transceivers 340, the one or more processors 306, memory 304, and/or V2X-BEV component 318, any or all of which may be considered means for performing this operation. In an aspect, operation 810 may be performed by the one or more WWAN transceivers 410, the one or more short-range wireless transceivers 420, the one or more processors 442, memory 440, and/or V2X-BEV component 448, any or all of which may be considered means for performing this operation.

At operation 820, the V2X-capable vehicle may transmit one or more messages indicating the association and a set of BEV features representing the BEV space other than the one or more features of the BEV space associated with the one or more V2X messages (i.e., the set of BEV features does not include the one or more features of the BEV space associated with the one or more V2X messages).

In an aspect, operation 820 may be performed by the one or more WWAN transceivers 330, the one or more short-range wireless transceivers 340, the one or more processors 306, memory 304, and/or V2X-BEV component 318, any or all of which may be considered means for performing this operation. In an aspect, operation 820 may be performed by the one or more WWAN transceivers 410, the one or more short-range wireless transceivers 420, the one or more processors 442, memory 440, and/or V2X-BEV component 448, any or all of which may be considered means for performing this operation.

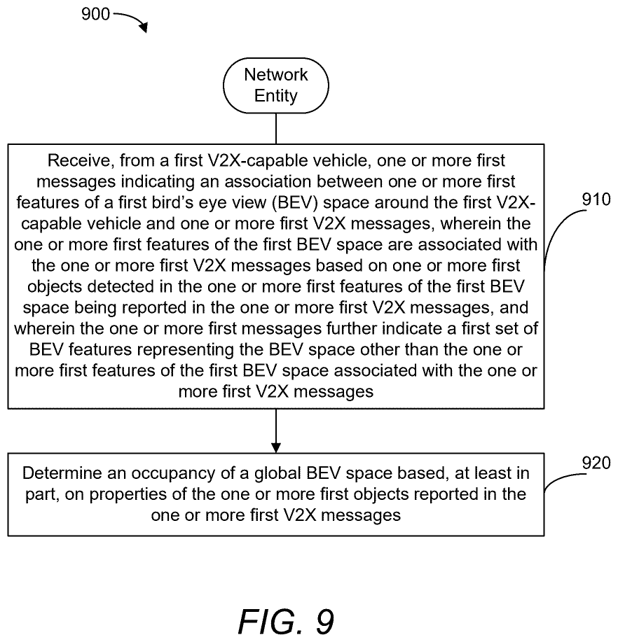

FIG. 9 illustrates an example method 900 of communication, according to aspects of the disclosure. In an aspect, method 900 may be performed by a network entity (e.g., C2C server 570).

At operation 910, the network entity may receive, from a first V2X-capable vehicle, one or more first messages indicating an association between one or more first features of a first BEV space around the first V2X-capable vehicle and one or more first V2X messages, where the one or more first features of the first BEV space is associated with the one or more first V2X messages based on one or more first objects detected in the one or more first features of the first BEV space being reported in the one or more first V2X messages, and where the one or more first messages further indicate a first set of BEV features representing the BEV space other than the one or more first features of the first BEV space associated with the one or more first V2X messages (i.e., the first set of BEV features does not include the one or more first features of the first BEV space associated with the one or more first V2X messages).

In an aspect, operation 910 may be performed the one or more network transceivers 490, the one or more processors 494, memory 496, and/or V2X-BEV component 498, any or all of which may be considered means for performing this operation.

At operation 920, the network entity may determine an occupancy of a global BEV space based, at least in part, on properties of the one or more first objects reported in the one or more first V2X messages.

In an aspect, operation 920 may be performed the one or more network transceivers 490, the one or more processors 494, memory 496, and/or V2X-BEV component 498, any or all of which may be considered means for performing this operation.

As will be appreciated, a technical advantage of the methods 800 and 900 is decreased signaling overhead when reporting BEV feature sets.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a vehicle-to-everything (V2X)-capable vehicle, comprising: determining an association between one or more features of a bird's eye view (BEV) space around the V2X-capable vehicle and one or more V2X messages, wherein the one or more features of the BEV space are associated with the one or more V2X messages based on one or more objects detected in the one or more features of the BEV space being reported in the one or more V2X messages; and transmitting one or more messages indicating the association and a set of BEV features representing the BEV space other than the one or more features of the BEV space associated with the one or more V2X messages.

Clause 2. The method of clause 1, wherein the one or more messages indicate the association based on the one or more messages including: message identifiers of the one or more V2X messages, object identifiers of the one or more objects included in the one or more V2X messages, or any combination thereof.

Clause 3. The method of any of clauses 1 to 2, wherein the one or more messages indicate the association based on the one or more messages indicating: a bounding box within the BEV space, a set of coordinates within the BEV space, or a set of matrix elements within the BEV space.

Clause 4. The method of any of clauses 1 to 3, wherein: the one or more V2X messages include a first V2X message transmitted by the V2X-capable vehicle, the one or more V2X messages include a second V2X message transmitted by a second V2X-capable vehicle, a transformation matrix is determined between a first bounding box around the one or more features of the BEV space in a coordinate space of the V2X-capable vehicle and a second bounding box around the one or more features of the BEV space in a coordinate space of the second V2X-capable vehicle, and the one or more messages indicate the association based on an alignment between the first bounding box and the second bounding box being greater than a threshold.

Clause 5. The method of any of clauses 1 to 4, further comprising: receiving the one or more V2X messages from one or more other V2X-capable vehicles.

Clause 6. The method of any of clauses 1 to 5, further comprising: transmitting the one or more V2X messages.

Clause 7. The method of clause 6, wherein: the one or more V2X messages include a message identifier of a most recent V2X message that included velocity vectors for the one or more objects, the one or more V2X messages include current trajectories of the one or more objects based on the current trajectories differing from previously reported trajectories of the one or more objects, the one or more V2X messages include accelerations of the one or more objects detected since the most recent V2X message including the velocity vectors for the one or more objects, the one or more V2X messages do not include object classifications of the one or more objects based on the object classifications having been previously reported, the one or more V2X messages include behavior identifiers of the one or more objects indicating motion patterns of the one or more objects, or any combination thereof.

Clause 8. The method of clause 7, wherein: the one or more V2X messages include the message identifier of the most recent V2X message including the velocity vectors for the one or more objects, and the one or more V2X messages further include: object identifiers of the one or more objects, current velocities of the one or more objects, and a timestamp.

Clause 9. The method of any of clauses 6 to 8, wherein the one or more V2X messages are transmitted to: other V2X-capable vehicles, a network entity, or any combination thereof.

Clause 10. The method of any of clauses 1 to 9, further comprising: receiving a configuration to report V2X messages for at least a first region of the BEV space and to report BEV features for at least a second region of the BEV space, wherein the one or more features of the BEV space are one or more BEV features of the second region of the BEV space.

Clause 11. The method of any of clauses 1 to 10, further comprising: receiving a configuration to report a first type of V2X messages for at least a first region of the BEV space and to report a second type of V2X messages for at least a second region of the BEV space.

Clause 12. The method of any of clauses 1 to 11, further comprising: receiving a configuration to report a first type of V2X messages for at least a first region of the BEV space for a first time period and to report a second type of V2X messages for at least a second region of the BEV space for a second time period.

Clause 13. The method of any of clauses 1 to 12, further comprising: receiving a configuration to report BEV features for at least a region of the BEV space based on at least the region of the BEV space not being reported by other V2X-capable vehicles.

Clause 14. The method of any of clauses 1 to 13, wherein: each feature of the set of BEV features is represented by a set of matrix elements of an image.

Clause 15. The method of any of clauses 1 to 14, wherein the one or more messages are transmitted to: other V2X-capable vehicles, a network entity, or any combination thereof.

Clause 16. A method of communication performed by a network entity, comprising: receiving, from a first V2X-capable vehicle, one or more first messages indicating an association between one or more first features of a first bird's eye view (BEV) space around the first V2X-capable vehicle and one or more first V2X messages, wherein the one or more first features of the first BEV space is associated with the one or more first V2X messages based on one or more first objects detected in the one or more first features of the first BEV space being reported in the one or more first V2X messages, and wherein the one or more first messages further indicate a first set of BEV features representing the BEV space other than the one or more first features of the first BEV space associated with the one or more first V2X messages; and determining an occupancy of a global BEV space based, at least in part, on properties of the one or more first objects reported in the one or more first V2X messages.

Clause 17. The method of clause 16, wherein: the one or more first V2X messages indicate the properties of the one or more first objects at a first time, and the occupancy of the global BEV space is determined for a second time after the first time based on the properties of the one or more first objects at a first time.

Clause 18. The method of any of clauses 16 to 17, wherein the properties of the one or more first objects include: positions of the one or more first objects, velocities of the one or more first objects, accelerations of the one or more first objects, headings of the one or more first objects, object types of the one or more first objects, or any combination thereof.

Clause 19. The method of any of clauses 16 to 18, further comprising: receiving, from a second V2X-capable vehicle, one or more second messages indicating an association between a second feature of a second BEV space around the second V2X-capable vehicle and one or more second V2X messages, wherein the second feature of the second BEV space is associated with the one or more second V2X messages based on one or more second objects detected in the second feature of the second BEV space being reported in the one or more second V2X messages, and wherein the one or more second messages further indicate a second set of BEV features representing the second BEV space, and wherein the second set of BEV features does not include the second feature of the second BEV space associated with the one or more second V2X messages.

Clause 20. The method of any of clauses 16 to 19, wherein the one or more first messages indicate the association based on the one or more first messages including: message identifiers of the one or more first V2X messages, object identifiers of the one or more first objects included in the one or more first V2X messages, or any combination thereof.

Clause 21. The method of any of clauses 16 to 20, wherein the one or more first messages indicate the association based on the one or more first messages indicating: a bounding box within the first BEV space, a set of coordinates within the first BEV space, or a set of matrix elements within the first BEV space.

Clause 22. The method of any of clauses 16 to 21, wherein: the one or more first V2X messages include a message identifier of a most recent V2X message that included velocity vectors for the one or more first objects, the one or more first V2X messages include current trajectories of the one or more first objects based on the current trajectories differing from previously reported trajectories of the one or more first objects, the one or more first V2X messages include accelerations of the one or more first objects detected since the most recent V2X message including the velocity vectors for the one or more first objects, the one or more first V2X messages do not include object classifications of the one or more first objects based on the object classifications having been previously reported, the one or more first V2X messages include behavior identifiers of the one or more first objects indicating motion patterns of the one or more first objects, or any combination thereof.

Clause 23. The method of any of clauses 16 to 22, further comprising: transmitting, to the first V2X-capable vehicle, a configuration to report V2X messages for at least a first region of the first BEV space and to report BEV features for at least a second region of the first BEV space, wherein the one or more first features of the first BEV space are one or more BEV features of the second region of the first BEV space.

Clause 24. The method of any of clauses 16 to 23, further comprising: transmitting, to the first V2X-capable vehicle, a configuration to report a first type of V2X messages for at least a first region of the BEV space and to report a second type of V2X messages for at least a second region of the BEV space.

Clause 25. The method of any of clauses 16 to 24, further comprising: transmitting, to the first V2X-capable vehicle, a configuration to report a first type of V2X messages for at least a first region of the BEV space for a first time period and to report a second type of V2X messages for at least a second region of the BEV space for a second time period.

Clause 26. The method of any of clauses 16 to 25, further comprising: transmitting, to the first V2X-capable vehicle, a configuration to report BEV features for at least a region of the BEV space based on at least the region of the BEV space not being reported by other V2X-capable vehicles.

Clause 27. The method of any of clauses 16 to 26, wherein: each feature of the first set of BEV features is represented by a set of matrix elements of an image.

Clause 28. A vehicle-to-everything (V2X)-capable vehicle, comprising: one or more memories; one or more transceivers; and one or more processors communicatively coupled to the one or more memories and the one or more transceivers, the one or more processors, either alone or in combination, configured to: determine an association between a feature of a bird's eye view (BEV) space around the V2X-capable vehicle and one or more V2X messages, wherein the one or more features of the BEV space are associated with the one or more V2X messages based on one or more objects detected in the one or more features of the BEV space being reported in the one or more V2X messages; and transmit, via the one or more transceivers, one or more messages indicating the association and a set of BEV features representing the BEV space other than the one or more features of the BEV space associated with the one or more V2X messages.

Clause 29. The V2X-capable vehicle of clause 28, wherein the one or more messages indicate the association based on the one or more messages including: message identifiers of the one or more V2X messages, object identifiers of the one or more objects included in the one or more V2X messages, or any combination thereof.

Clause 30. The V2X-capable vehicle of any of clauses 28 to 29, wherein the one or more messages indicate the association based on the one or more messages indicating: a bounding box within the BEV space, a set of coordinates within the BEV space, or a set of matrix elements within the BEV space.

Clause 31. The V2X-capable vehicle of any of clauses 28 to 30, wherein: the one or more V2X messages include a first V2X message transmitted by the V2X-capable vehicle, the one or more V2X messages include a second V2X message transmitted by a second V2X-capable vehicle, a transformation matrix is determined between a first bounding box around the one or more features of the BEV space in a coordinate space of the V2X-capable vehicle and a second bounding box around the one or more features of the BEV space in a coordinate space of the second V2X-capable vehicle, and the one or more messages indicate the association based on an alignment between the first bounding box and the second bounding box being greater than a threshold.

Clause 32. The V2X-capable vehicle of any of clauses 28 to 31, wherein the one or more processors, either alone or in combination, are further configured to: receive, via the one or more transceivers, the one or more V2X messages from one or more other V2X-capable vehicles.

Clause 33. The V2X-capable vehicle of any of clauses 28 to 32, wherein the one or more processors, either alone or in combination, are further configured to: transmit, via the one or more transceivers, the one or more V2X messages.

Clause 34. The V2X-capable vehicle of clause 33, wherein: the one or more V2X messages include a message identifier of a most recent V2X message that included velocity vectors for the one or more objects, the one or more V2X messages include current trajectories of the one or more objects based on the current trajectories differing from previously reported trajectories of the one or more objects, the one or more V2X messages include accelerations of the one or more objects detected since the most recent V2X message including the velocity vectors for the one or more objects, the one or more V2X messages do not include object classifications of the one or more objects based on the object classifications having been previously reported, the one or more V2X messages include behavior identifiers of the one or more objects indicating motion patterns of the one or more objects, or any combination thereof.

Clause 35. The V2X-capable vehicle of clause 34, wherein: the one or more V2X messages include the message identifier of the most recent V2X message including the velocity vectors for the one or more objects, and the one or more V2X messages further include: object identifiers of the one or more objects, current velocities of the one or more objects, and a timestamp.

Clause 36. The V2X-capable vehicle of any of clauses 33 to 35, wherein the one or more V2X messages are transmitted to: other V2X-capable vehicles, a network entity, or any combination thereof.

Clause 37. The V2X-capable vehicle of any of clauses 28 to 36, wherein the one or more processors, either alone or in combination, are further configured to: receive, via the one or more transceivers, a configuration to report V2X messages for at least a first region of the BEV space and to report BEV features for at least a second region of the BEV space, wherein the one or more features of the BEV space are one or more BEV features of the second region of the BEV space.

Clause 38. The V2X-capable vehicle of any of clauses 28 to 37, wherein the one or more processors, either alone or in combination, are further configured to: receive, via the one or more transceivers, a configuration to report a first type of V2X messages for at least a first region of the BEV space and to report a second type of V2X messages for at least a second region of the BEV space.

Clause 39. The V2X-capable vehicle of any of clauses 28 to 38, wherein the one or more processors, either alone or in combination, are further configured to: receive, via the one or more transceivers, a configuration to report a first type of V2X messages for at least a first region of the BEV space for a first time period and to report a second type of V2X messages for at least a second region of the BEV space for a second time period.

Clause 40. The V2X-capable vehicle of any of clauses 28 to 39, wherein the one or more processors, either alone or in combination, are further configured to: receive, via the one or more transceivers, a configuration to report BEV features for at least a region of the BEV space based on at least the region of the BEV space not being reported by other V2X-capable vehicles.

Clause 41. The V2X-capable vehicle of any of clauses 28 to 40, wherein: each feature of the set of BEV features is represented by a set of matrix elements of an image.

Clause 42. The V2X-capable vehicle of any of clauses 28 to 41, wherein the one or more messages are transmitted to: other V2X-capable vehicles, a network entity, or any combination thereof.

Clause 43. A network entity, comprising: one or more memories; one or more transceivers; and one or more processors communicatively coupled to the one or more memories and the one or more transceivers, the one or more processors, either alone or in combination, configured to: receive, via the one or more transceivers, from a first V2X-capable vehicle, one or more first messages indicating an association between one or more first features of a first bird's eye view (BEV) space around the first V2X-capable vehicle and one or more first V2X messages, wherein the one or more first features of the first BEV space is associated with the one or more first V2X messages based on one or more first objects detected in the one or more first features of the first BEV space being reported in the one or more first V2X messages, and wherein the one or more first messages further indicate a first set of BEV features representing the BEV space other than the one or more first features of the first BEV space associated with the one or more first V2X messages; and determine an occupancy of a global BEV space based, at least in part, on properties of the one or more first objects reported in the one or more first V2X messages.

Clause 44. The network entity of clause 43, wherein: the one or more first V2X messages indicate the properties of the one or more first objects at a first time, and the occupancy of the global BEV space is determined for a second time after the first time based on the properties of the one or more first objects at a first time.

Clause 45. The network entity of any of clauses 43 to 44, wherein the properties of the one or more first objects include: positions of the one or more first objects, velocities of the one or more first objects, accelerations of the one or more first objects, headings of the one or more first objects, object types of the one or more first objects, or any combination thereof.

Clause 46. The network entity of any of clauses 43 to 45, wherein the one or more processors, either alone or in combination, are further configured to: receive, via the one or more transceivers, from a second V2X-capable vehicle, one or more second messages indicating an association between a second feature of a second BEV space around the second V2X-capable vehicle and one or more second V2X messages, wherein the second feature of the second BEV space is associated with the one or more second V2X messages based on one or more second objects detected in the second feature of the second BEV space being reported in the one or more second V2X messages, and wherein the one or more second messages further indicate a second set of BEV features representing the second BEV space, and wherein the second set of BEV features does not include the second feature of the second BEV space associated with the one or more second V2X messages.

Clause 47. The network entity of any of clauses 43 to 46, wherein the one or more first messages indicate the association based on the one or more first messages including: message identifiers of the one or more first V2X messages, object identifiers of the one or more first objects included in the one or more first V2X messages, or any combination thereof.

Clause 48. The network entity of any of clauses 43 to 47, wherein the one or more first messages indicate the association based on the one or more first messages indicating: a bounding box within the first BEV space, a set of coordinates within the first BEV space, or a set of matrix elements within the first BEV space.

Clause 49. The network entity of any of clauses 43 to 48, wherein: the one or more first V2X messages include a message identifier of a most recent V2X message that included velocity vectors for the one or more first objects, the one or more first V2X messages include current trajectories of the one or more first objects based on the current trajectories differing from previously reported trajectories of the one or more first objects, the one or more first V2X messages include accelerations of the one or more first objects detected since the most recent V2X message including the velocity vectors for the one or more first objects, the one or more first V2X messages do not include object classifications of the one or more first objects based on the object classifications having been previously reported, the one or more first V2X messages include behavior identifiers of the one or more first objects indicating motion patterns of the one or more first objects, or any combination thereof.

Clause 50. The network entity of any of clauses 43 to 49, wherein the one or more processors, either alone or in combination, are further configured to: transmit, via the one or more transceivers, to the first V2X-capable vehicle, a configuration to report V2X messages for at least a first region of the first BEV space and to report BEV features for at least a second region of the first BEV space, wherein the one or more first features of the first BEV space are one or more BEV features of the second region of the first BEV space.

Clause 51. The network entity of any of clauses 43 to 50, wherein the one or more processors, either alone or in combination, are further configured to: transmit, via the one or more transceivers, to the first V2X-capable vehicle, a configuration to report a first type of V2X messages for at least a first region of the BEV space and to report a second type of V2X messages for at least a second region of the BEV space.

Clause 52. The network entity of any of clauses 43 to 51, wherein the one or more processors, either alone or in combination, are further configured to: transmit, via the one or more transceivers, to the first V2X-capable vehicle, a configuration to report a first type of V2X messages for at least a first region of the BEV space for a first time period and to report a second type of V2X messages for at least a second region of the BEV space for a second time period.

Clause 53. The network entity of any of clauses 43 to 52, wherein the one or more processors, either alone or in combination, are further configured to: transmit, via the one or more transceivers, to the first V2X-capable vehicle, a configuration to report BEV features for at least a region of the BEV space based on at least the region of the BEV space not being reported by other V2X-capable vehicles.

Clause 54. The network entity of any of clauses 43 to 53, wherein: each feature of the first set of BEV features is represented by a set of matrix elements of an image.

Clause 55. A vehicle-to-everything (V2X)-capable vehicle, comprising: means for determining an association between one or more features of a bird's eye view (BEV) space around the V2X-capable vehicle and one or more V2X messages, wherein the one or more features of the BEV space are associated with the one or more V2X messages based on one or more objects detected in the one or more features of the BEV space being reported in the one or more V2X messages; and means for transmitting one or more messages indicating the association and a set of BEV features representing the BEV space other than the one or more features of the BEV space associated with the one or more V2X messages.

Clause 56. The V2X-capable vehicle of clause 55, wherein the one or more messages indicate the association based on the one or more messages including: message identifiers of the one or more V2X messages, object identifiers of the one or more objects included in the one or more V2X messages, or any combination thereof.

Clause 57. The V2X-capable vehicle of any of clauses 55 to 56, wherein the one or more messages indicate the association based on the one or more messages indicating: a bounding box within the BEV space, a set of coordinates within the BEV space, or a set of matrix elements within the BEV space.

Clause 58. The V2X-capable vehicle of any of clauses 55 to 57, wherein: the one or more V2X messages include a first V2X message transmitted by the V2X-capable vehicle, the one or more V2X messages include a second V2X message transmitted by a second V2X-capable vehicle, a transformation matrix is determined between a first bounding box around the one or more features of the BEV space in a coordinate space of the V2X-capable vehicle and a second bounding box around the one or more features of the BEV space in a coordinate space of the second V2X-capable vehicle, and the one or more messages indicate the association based on an alignment between the first bounding box and the second bounding box being greater than a threshold.

Clause 59. The V2X-capable vehicle of any of clauses 55 to 58, further comprising: means for receiving the one or more V2X messages from one or more other V2X-capable vehicles.

Clause 60. The V2X-capable vehicle of any of clauses 55 to 59, further comprising: means for transmitting the one or more V2X messages.

Clause 61. The V2X-capable vehicle of clause 60, wherein: the one or more V2X messages include a message identifier of a most recent V2X message that included velocity vectors for the one or more objects, the one or more V2X messages include current trajectories of the one or more objects based on the current trajectories differing from previously reported trajectories of the one or more objects, the one or more V2X messages include accelerations of the one or more objects detected since the most recent V2X message including the velocity vectors for the one or more objects, the one or more V2X messages do not include object classifications of the one or more objects based on the object classifications having been previously reported, the one or more V2X messages include behavior identifiers of the one or more objects indicating motion patterns of the one or more objects, or any combination thereof.

Clause 62. The V2X-capable vehicle of clause 61, wherein: the one or more V2X messages include the message identifier of the most recent V2X message including the velocity vectors for the one or more objects, and the one or more V2X messages further include: object identifiers of the one or more objects, current velocities of the one or more objects, and a timestamp.

Clause 63. The V2X-capable vehicle of any of clauses 60 to 62, wherein the one or more V2X messages are transmitted to: other V2X-capable vehicles, a network entity, or any combination thereof.

Clause 64. The V2X-capable vehicle of any of clauses 55 to 63, further comprising: means for receiving a configuration to report V2X messages for at least a first region of the BEV space and to report BEV features for at least a second region of the BEV space, wherein the one or more features of the BEV space are one or more BEV features of the second region of the BEV space.

Clause 65. The V2X-capable vehicle of any of clauses 55 to 64, further comprising: means for receiving a configuration to report a first type of V2X messages for at least a first region of the BEV space and to report a second type of V2X messages for at least a second region of the BEV space.

Clause 66. The V2X-capable vehicle of any of clauses 55 to 65, further comprising: means for receiving a configuration to report a first type of V2X messages for at least a first region of the BEV space for a first time period and to report a second type of V2X messages for at least a second region of the BEV space for a second time period.

Clause 67. The V2X-capable vehicle of any of clauses 55 to 66, further comprising: means for receiving a configuration to report BEV features for at least a region of the BEV space based on at least the region of the BEV space not being reported by other V2X-capable vehicles.

Clause 68. The V2X-capable vehicle of any of clauses 55 to 67, wherein: each feature of the set of BEV features is represented by a set of matrix elements of an image.

Clause 69. The V2X-capable vehicle of any of clauses 55 to 68, wherein the one or more messages are transmitted to: other V2X-capable vehicles, a network entity, or any combination thereof.

Clause 70. A network entity, comprising: means for receiving, from a first V2X-capable vehicle, one or more first messages indicating an association between one or more first features of a first bird's eye view (BEV) space around the first V2X-capable vehicle and one or more first V2X messages, wherein the one or more first features of the first BEV space is associated with the one or more first V2X messages based on one or more first objects detected in the one or more first features of the first BEV space being reported in the one or more first V2X messages, and wherein the one or more first messages further indicate a first set of BEV features representing the BEV space other than the one or more first features of the first BEV space associated with the one or more first V2X messages; and means for determining an occupancy of a global BEV space based, at least in part, on properties of the one or more first objects reported in the one or more first V2X messages.

Clause 71. The network entity of clause 70, wherein: the one or more first V2X messages indicate the properties of the one or more first objects at a first time, and the occupancy of the global BEV space is determined for a second time after the first time based on the properties of the one or more first objects at a first time.

Clause 72. The network entity of any of clauses 70 to 71, wherein the properties of the one or more first objects include: positions of the one or more first objects, velocities of the one or more first objects, accelerations of the one or more first objects, headings of the one or more first objects, object types of the one or more first objects, or any combination thereof.

Clause 73. The network entity of any of clauses 70 to 72, further comprising: means for receiving, from a second V2X-capable vehicle, one or more second messages indicating an association between a second feature of a second BEV space around the second V2X-capable vehicle and one or more second V2X messages, wherein the second feature of the second BEV space is associated with the one or more second V2X messages based on one or more second objects detected in the second feature of the second BEV space being reported in the one or more second V2X messages, and wherein the one or more second messages further indicate a second set of BEV features representing the second BEV space, and wherein the second set of BEV features does not include the second feature of the second BEV space associated with the one or more second V2X messages.

Clause 74. The network entity of any of clauses 70 to 73, wherein the one or more first messages indicate the association based on the one or more first messages including: message identifiers of the one or more first V2X messages, object identifiers of the one or more first objects included in the one or more first V2X messages, or any combination thereof.

Clause 75. The network entity of any of clauses 70 to 74, wherein the one or more first messages indicate the association based on the one or more first messages indicating: a bounding box within the first BEV space, a set of coordinates within the first BEV space, or a set of matrix elements within the first BEV space.

Clause 76. The network entity of any of clauses 70 to 75, wherein: the one or more first V2X messages include a message identifier of a most recent V2X message that included velocity vectors for the one or more first objects, the one or more first V2X messages include current trajectories of the one or more first objects based on the current trajectories differing from previously reported trajectories of the one or more first objects, the one or more first V2X messages include accelerations of the one or more first objects detected since the most recent V2X message including the velocity vectors for the one or more first objects, the one or more first V2X messages do not include object classifications of the one or more first objects based on the object classifications having been previously reported, the one or more first V2X messages include behavior identifiers of the one or more first objects indicating motion patterns of the one or more first objects, or any combination thereof.

Clause 77. The network entity of any of clauses 70 to 76, further comprising: means for transmitting, to the first V2X-capable vehicle, a configuration to report V2X messages for at least a first region of the first BEV space and to report BEV features for at least a second region of the first BEV space, wherein the one or more first features of the first BEV space are one or more BEV features of the second region of the first BEV space.

Clause 78. The network entity of any of clauses 70 to 77, further comprising: means for transmitting, to the first V2X-capable vehicle, a configuration to report a first type of V2X messages for at least a first region of the BEV space and to report a second type of V2X messages for at least a second region of the BEV space.

Clause 79. The network entity of any of clauses 70 to 78, further comprising: means for transmitting, to the first V2X-capable vehicle, a configuration to report a first type of V2X messages for at least a first region of the BEV space for a first time period and to report a second type of V2X messages for at least a second region of the BEV space for a second time period.

Clause 80. The network entity of any of clauses 70 to 79, further comprising: means for transmitting, to the first V2X-capable vehicle, a configuration to report BEV features for at least a region of the BEV space based on at least the region of the BEV space not being reported by other V2X-capable vehicles.

Clause 81. The network entity of any of clauses 70 to 80, wherein: each feature of the first set of BEV features is represented by a set of matrix elements of an image.

Clause 82. A non-transitory computer-readable medium storing computer-executable instructions that, when executed by a vehicle-to-everything (V2X)-capable vehicle, cause the V2X-capable vehicle to: determine an association between one or more features of a bird's eye view (BEV) space around the V2X-capable vehicle and one or more V2X messages, wherein the one or more features of the BEV space are associated with the one or more V2X messages based on one or more objects detected in the one or more features of the BEV space being reported in the one or more V2X messages; and transmit one or more messages indicating the association and a set of BEV features representing the BEV space other than the one or more features of the BEV space associated with the one or more V2X messages.

Clause 83. The non-transitory computer-readable medium of clause 82, wherein the one or more messages indicate the association based on the one or more messages including: message identifiers of the one or more V2X messages, object identifiers of the one or more objects included in the one or more V2X messages, or any combination thereof.

Clause 84. The non-transitory computer-readable medium of any of clauses 82 to 83, wherein the one or more messages indicate the association based on the one or more messages indicating: a bounding box within the BEV space, a set of coordinates within the BEV space, or a set of matrix elements within the BEV space.

Clause 85. The non-transitory computer-readable medium of any of clauses 82 to 84, wherein: the one or more V2X messages include a first V2X message transmitted by the V2X-capable vehicle, the one or more V2X messages include a second V2X message transmitted by a second V2X-capable vehicle, a transformation matrix is determined between a first bounding box around the one or more features of the BEV space in a coordinate space of the V2X-capable vehicle and a second bounding box around the one or more features of the BEV space in a coordinate space of the second V2X-capable vehicle, and the one or more messages indicate the association based on an alignment between the first bounding box and the second bounding box being greater than a threshold.

Clause 86. The non-transitory computer-readable medium of any of clauses 82 to 85, further comprising computer-executable instructions that, when executed by the V2X-capable vehicle, cause the V2X-capable vehicle to: receive the one or more V2X messages from one or more other V2X-capable vehicles.

Clause 87. The non-transitory computer-readable medium of any of clauses 82 to 86, further comprising computer-executable instructions that, when executed by the V2X-capable vehicle, cause the V2X-capable vehicle to: transmit the one or more V2X messages.

Clause 88. The non-transitory computer-readable medium of clause 87, wherein: the one or more V2X messages include a message identifier of a most recent V2X message that included velocity vectors for the one or more objects, the one or more V2X messages include current trajectories of the one or more objects based on the current trajectories differing from previously reported trajectories of the one or more objects, the one or more V2X messages include accelerations of the one or more objects detected since the most recent V2X message including the velocity vectors for the one or more objects, the one or more V2X messages do not include object classifications of the one or more objects based on the object classifications having been previously reported, the one or more V2X messages include behavior identifiers of the one or more objects indicating motion patterns of the one or more objects, or any combination thereof.

Clause 89. The non-transitory computer-readable medium of clause 88, wherein: the one or more V2X messages include the message identifier of the most recent V2X message including the velocity vectors for the one or more objects, and the one or more V2X messages further include: object identifiers of the one or more objects, current velocities of the one or more objects, and a timestamp.

Clause 90. The non-transitory computer-readable medium of any of clauses 87 to 89, wherein the one or more V2X messages are transmitted to: other V2X-capable vehicles, a network entity, or any combination thereof.

Clause 91. The non-transitory computer-readable medium of any of clauses 82 to 90, further comprising computer-executable instructions that, when executed by the V2X-capable vehicle, cause the V2X-capable vehicle to: receive a configuration to report V2X messages for at least a first region of the BEV space and to report BEV features for at least a second region of the BEV space, wherein the one or more features of the BEV space are one or more BEV features of the second region of the BEV space.

Clause 92. The non-transitory computer-readable medium of any of clauses 82 to 91, further comprising computer-executable instructions that, when executed by the V2X-capable vehicle, cause the V2X-capable vehicle to: receive a configuration to report a first type of V2X messages for at least a first region of the BEV space and to report a second type of V2X messages for at least a second region of the BEV space.

Clause 93. The non-transitory computer-readable medium of any of clauses 82 to 92, further comprising computer-executable instructions that, when executed by the V2X-capable vehicle, cause the V2X-capable vehicle to: receive a configuration to report a first type of V2X messages for at least a first region of the BEV space for a first time period and to report a second type of V2X messages for at least a second region of the BEV space for a second time period.

Clause 94. The non-transitory computer-readable medium of any of clauses 82 to 93, further comprising computer-executable instructions that, when executed by the V2X-capable vehicle, cause the V2X-capable vehicle to: receive a configuration to report BEV features for at least a region of the BEV space based on at least the region of the BEV space not being reported by other V2X-capable vehicles.

Clause 95. The non-transitory computer-readable medium of any of clauses 82 to 94, wherein: each feature of the set of BEV features is represented by a set of matrix elements of an image.

Clause 96. The non-transitory computer-readable medium of any of clauses 82 to 95, wherein the one or more messages are transmitted to: other V2X-capable vehicles, a network entity, or any combination thereof.

Clause 97. A non-transitory computer-readable medium storing computer-executable instructions that, when executed by a network entity, cause the network entity to: receive, from a first V2X-capable vehicle, one or more first messages indicating an association between one or more first features of a first bird's eye view (BEV) space around the first V2X-capable vehicle and one or more first V2X messages, wherein the one or more first features of the first BEV space is associated with the one or more first V2X messages based on one or more first objects detected in the one or more first features of the first BEV space being reported in the one or more first V2X messages, and wherein the one or more first messages further indicate a first set of BEV features representing the BEV space other than the one or more first features of the first BEV space associated with the one or more first V2X messages; and determine an occupancy of a global BEV space based, at least in part, on properties of the one or more first objects reported in the one or more first V2X messages.

Clause 98. The non-transitory computer-readable medium of clause 97, wherein: the one or more first V2X messages indicate the properties of the one or more first objects at a first time, and the occupancy of the global BEV space is determined for a second time after the first time based on the properties of the one or more first objects at a first time.

Clause 99. The non-transitory computer-readable medium of any of clauses 97 to 98, wherein the properties of the one or more first objects include: positions of the one or more first objects, velocities of the one or more first objects, accelerations of the one or more first objects, headings of the one or more first objects, object types of the one or more first objects, or any combination thereof.

Clause 100. The non-transitory computer-readable medium of any of clauses 97 to 99, further comprising computer-executable instructions that, when executed by the network entity, cause the network entity to: receive, from a second V2X-capable vehicle, one or more second messages indicating an association between a second feature of a second BEV space around the second V2X-capable vehicle and one or more second V2X messages, wherein the second feature of the second BEV space is associated with the one or more second V2X messages based on one or more second objects detected in the second feature of the second BEV space being reported in the one or more second V2X messages, and wherein the one or more second messages further indicate a second set of BEV features representing the second BEV space, and wherein the second set of BEV features does not include the second feature of the second BEV space associated with the one or more second V2X messages.

Clause 101. The non-transitory computer-readable medium of any of clauses 97 to 100, wherein the one or more first messages indicate the association based on the one or more first messages including: message identifiers of the one or more first V2X messages, object identifiers of the one or more first objects included in the one or more first V2X messages, or any combination thereof.

Clause 102. The non-transitory computer-readable medium of any of clauses 97 to 101, wherein the one or more first messages indicate the association based on the one or more first messages indicating: a bounding box within the first BEV space, a set of coordinates within the first BEV space, or a set of matrix elements within the first BEV space.

Clause 103. The non-transitory computer-readable medium of any of clauses 97 to 102, wherein: the one or more first V2X messages include a message identifier of a most recent V2X message that included velocity vectors for the one or more first objects, the one or more first V2X messages include current trajectories of the one or more first objects based on the current trajectories differing from previously reported trajectories of the one or more first objects, the one or more first V2X messages include accelerations of the one or more first objects detected since the most recent V2X message including the velocity vectors for the one or more first objects, the one or more first V2X messages do not include object classifications of the one or more first objects based on the object classifications having been previously reported, the one or more first V2X messages include behavior identifiers of the one or more first objects indicating motion patterns of the one or more first objects, or any combination thereof.

Clause 104. The non-transitory computer-readable medium of any of clauses 97 to 103, further comprising computer-executable instructions that, when executed by the network entity, cause the network entity to: transmit, to the first V2X-capable vehicle, a configuration to report V2X messages for at least a first region of the first BEV space and to report BEV features for at least a second region of the first BEV space, wherein the one or more first features of the first BEV space are one or more BEV features of the second region of the first BEV space.

Clause 105. The non-transitory computer-readable medium of any of clauses 97 to 104, further comprising computer-executable instructions that, when executed by the network entity, cause the network entity to: transmit, to the first V2X-capable vehicle, a configuration to report a first type of V2X messages for at least a first region of the BEV space and to report a second type of V2X messages for at least a second region of the BEV space.

Clause 106. The non-transitory computer-readable medium of any of clauses 97 to 105, further comprising computer-executable instructions that, when executed by the network entity, cause the network entity to: transmit, to the first V2X-capable vehicle, a configuration to report a first type of V2X messages for at least a first region of the BEV space for a first time period and to report a second type of V2X messages for at least a second region of the BEV space for a second time period.

Clause 107. The non-transitory computer-readable medium of any of clauses 97 to 106, further comprising computer-executable instructions that, when executed by the network entity, cause the network entity to: transmit, to the first V2X-capable vehicle, a configuration to report BEV features for at least a region of the BEV space based on at least the region of the BEV space not being reported by other V2X-capable vehicles.

Clause 108. The non-transitory computer-readable medium of any of clauses 97 to 107, wherein: each feature of the first set of BEV features is represented by a set of matrix elements of an image.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

1. A method of wireless communication performed by a vehicle-to-everything (V2X)-capable vehicle, comprising:
determining an association between one or more features of a bird's eye view (BEV) space around the V2X-capable vehicle and one or more V2X messages, wherein the one or more features of the BEV space are associated with the one or more V2X messages based on one or more objects detected in the one or more features of the BEV space being reported in the one or more V2X messages; and
transmitting one or more messages indicating the association and a set of BEV features representing the BEV space other than the one or more features of the BEV space associated with the one or more V2X messages.

2. The method of claim 1, wherein the one or more messages indicate the association based on the one or more messages including:
message identifiers of the one or more V2X messages,
object identifiers of the one or more objects included in the one or more V2X messages, or
any combination thereof.

3. The method of claim 1, wherein the one or more messages indicate the association based on the one or more messages indicating:
a bounding box within the BEV space,
a set of coordinates within the BEV space, or
a set of matrix elements within the BEV space.

4. The method of claim 1, wherein:
the one or more V2X messages include a first V2X message transmitted by the V2X-capable vehicle,
the one or more V2X messages include a second V2X message transmitted by a second V2X-capable vehicle,
a transformation matrix is determined between a first bounding box around the one or more features of the BEV space in a coordinate space of the V2X-capable vehicle and a second bounding box around the one or more features of the BEV space in a coordinate space of the second V2X-capable vehicle, and
the one or more messages indicate the association based on an alignment between the first bounding box and the second bounding box being greater than a threshold.

5. The method of claim 1, further comprising:
receiving the one or more V2X messages from one or more other V2X-capable vehicles.

6. The method of claim 1, further comprising:
transmitting the one or more V2X messages.

7. The method of claim 6, wherein:
the one or more V2X messages include a message identifier of a most recent V2X message that included velocity vectors for the one or more objects,
the one or more V2X messages include current trajectories of the one or more objects based on the current trajectories differing from previously reported trajectories of the one or more objects,
the one or more V2X messages include accelerations of the one or more objects detected since the most recent V2X message including the velocity vectors for the one or more objects,
the one or more V2X messages do not include object classifications of the one or more objects based on the object classifications having been previously reported,
the one or more V2X messages include behavior identifiers of the one or more objects indicating motion patterns of the one or more objects, or
any combination thereof.

8. The method of claim 7, wherein:
the one or more V2X messages include the message identifier of the most recent V2X message including the velocity vectors for the one or more objects, and
the one or more V2X messages further include:
object identifiers of the one or more objects,
current velocities of the one or more objects, and
a timestamp.

9. The method of claim 6, wherein the one or more V2X messages are transmitted to:
other V2X-capable vehicles,
a network entity, or
any combination thereof.

10. The method of claim 1, further comprising:
receiving a configuration to report V2X messages for at least a first region of the BEV space and to report BEV features for at least a second region of the BEV space, wherein the one or more features of the BEV space are one or more BEV features of the second region of the BEV space.

11. The method of claim 1, further comprising:
receiving a configuration to report a first type of V2X messages for at least a first region of the BEV space and to report a second type of V2X messages for at least a second region of the BEV space.

12. The method of claim 1, further comprising:
receiving a configuration to report a first type of V2X messages for at least a first region of the BEV space for a first time period and to report a second type of V2X messages for at least a second region of the BEV space for a second time period.

13. The method of claim 1, further comprising:
receiving a configuration to report BEV features for at least a region of the BEV space based on at least the region of the BEV space not being reported by other V2X-capable vehicles.

14. The method of claim 1, wherein:
each feature of the set of BEV features is represented by a set of matrix elements of an image.

15. The method of claim 1, wherein the one or more messages are transmitted to:
other V2X-capable vehicles,
a network entity, or
any combination thereof.

16. A method of communication performed by a network entity, comprising:
receiving, from a first V2X-capable vehicle, one or more first messages indicating an association between one or more first features of a first bird's eye view (BEV) space around the first V2X-capable vehicle and one or more first V2X messages, wherein the one or more first features of the first BEV space are associated with the one or more first V2X messages based on one or more first objects detected in the one or more first features of the first BEV space being reported in the one or more first V2X messages, and wherein the one or more first messages further indicate a first set of BEV features representing the BEV space other than the one or more first features of the first BEV space associated with the one or more first V2X messages; and
determining an occupancy of a global BEV space based, at least in part, on properties of the one or more first objects reported in the one or more first V2X messages.

17. The method of claim 16, wherein:
the one or more first V2X messages indicate the properties of the one or more first objects at a first time, and
the occupancy of the global BEV space is determined for a second time after the first time based on the properties of the one or more first objects at a first time.

18. The method of claim 16, wherein the properties of the one or more first objects include:
positions of the one or more first objects,
velocities of the one or more first objects,
accelerations of the one or more first objects,
headings of the one or more first objects,
object types of the one or more first objects, or
any combination thereof.

19. The method of claim 16, further comprising:
receiving, from a second V2X-capable vehicle, one or more second messages indicating an association between a second feature of a second BEV space around the second V2X-capable vehicle and one or more second V2X messages, wherein the second feature of the second BEV space is associated with the one or more second V2X messages based on one or more second objects detected in the second feature of the second BEV space being reported in the one or more second V2X messages, and wherein the one or more second messages further indicate a second set of BEV features representing the second BEV space, and wherein the second set of BEV features does not include the second feature of the second BEV space associated with the one or more second V2X messages.

20. The method of claim 16, wherein the one or more first messages indicate the association based on the one or more first messages including:
message identifiers of the one or more first V2X messages,
object identifiers of the one or more first objects included in the one or more first V2X messages, or
any combination thereof.

21. The method of claim 16, wherein the one or more first messages indicate the association based on the one or more first messages indicating:
a bounding box within the first BEV space,
a set of coordinates within the first BEV space, or
a set of matrix elements within the first BEV space.

22. The method of claim 16, wherein:
the one or more first V2X messages include a message identifier of a most recent V2X message that included velocity vectors for the one or more first objects,
the one or more first V2X messages include current trajectories of the one or more first objects based on the current trajectories differing from previously reported trajectories of the one or more first objects,
the one or more first V2X messages include accelerations of the one or more first objects detected since the most recent V2X message including the velocity vectors for the one or more first objects,
the one or more first V2X messages do not include object classifications of the one or more first objects based on the object classifications having been previously reported,
the one or more first V2X messages include behavior identifiers of the one or more first objects indicating motion patterns of the one or more first objects, or
any combination thereof.

23. The method of claim 16, further comprising:
transmitting, to the first V2X-capable vehicle, a configuration to report V2X messages for at least a first region of the first BEV space and to report BEV features for at least a second region of the first BEV space, wherein the one or more first features of the first BEV space are one or more BEV features of the second region of the first BEV space.

24. The method of claim 16, further comprising:
transmitting, to the first V2X-capable vehicle, a configuration to report a first type of V2X messages for at least a first region of the BEV space and to report a second type of V2X messages for at least a second region of the BEV space.

25. The method of claim 16, further comprising:
transmitting, to the first V2X-capable vehicle, a configuration to report a first type of V2X messages for at least a first region of the BEV space for a first time period and to report a second type of V2X messages for at least a second region of the BEV space for a second time period.

26. The method of claim 16, further comprising:
transmitting, to the first V2X-capable vehicle, a configuration to report BEV features for at least a region of the BEV space based on at least the region of the BEV space not being reported by other V2X-capable vehicles.

27. The method of claim 16, wherein:
each feature of the first set of BEV features is represented by a set of matrix elements of an image.

28. A vehicle-to-everything (V2X)-capable vehicle, comprising:
one or more memories;
one or more transceivers; and
one or more processors communicatively coupled to the one or more memories and the one or more transceivers, the one or more processors, either alone or in combination, configured to:
determine an association between one or more features of a bird's eye view (BEV) space around the V2X-capable vehicle and one or more V2X messages, wherein the one or more features of the BEV space are associated with the one or more V2X messages based on one or more objects detected in the one or more features of the BEV space being reported in the one or more V2X messages; and
transmit, via the one or more transceivers, one or more messages indicating the association and a set of BEV features representing the BEV space other than the one or more features of the BEV space associated with the one or more V2X messages.

29. The V2X-capable vehicle of claim 28, wherein the one or more messages indicate the association based on the one or more messages including:
message identifiers of the one or more V2X messages,
object identifiers of the one or more objects included in the one or more V2X messages, or
any combination thereof.

30. The V2X-capable vehicle of claim 28, wherein the one or more messages indicate the association based on the one or more messages indicating:
a bounding box within the BEV space,
a set of coordinates within the BEV space, or
a set of matrix elements within the BEV space.

31. The V2X-capable vehicle of claim 28, wherein:
the one or more V2X messages include a first V2X message transmitted by the V2X-capable vehicle,
the one or more V2X messages include a second V2X message transmitted by a second V2X-capable vehicle,
a transformation matrix is determined between a first bounding box around the one or more features of the BEV space in a coordinate space of the V2X-capable vehicle and a second bounding box around the one or more features of the BEV space in a coordinate space of the second V2X-capable vehicle, and
the one or more messages indicate the association based on an alignment between the first bounding box and the second bounding box being greater than a threshold.

32. The V2X-capable vehicle of claim 28, wherein the one or more processors, either alone or in combination, are further configured to:
receive, via the one or more transceivers, the one or more V2X messages from one or more other V2X-capable vehicles.

33. The V2X-capable vehicle of claim 28, wherein the one or more processors, either alone or in combination, are further configured to:
transmit, via the one or more transceivers, the one or more V2X messages.

34. The V2X-capable vehicle of claim 33, wherein:
the one or more V2X messages include a message identifier of a most recent V2X message that included velocity vectors for the one or more objects,
the one or more V2X messages include current trajectories of the one or more objects based on the current trajectories differing from previously reported trajectories of the one or more objects,
the one or more V2X messages include accelerations of the one or more objects detected since the most recent V2X message including the velocity vectors for the one or more objects,
the one or more V2X messages do not include object classifications of the one or more objects based on the object classifications having been previously reported,
the one or more V2X messages include behavior identifiers of the one or more objects indicating motion patterns of the one or more objects, or
any combination thereof.

35. The V2X-capable vehicle of claim 34, wherein:
the one or more V2X messages include the message identifier of the most recent V2X message including the velocity vectors for the one or more objects, and
the one or more V2X messages further include:
object identifiers of the one or more objects,
current velocities of the one or more objects, and
a timestamp.

36. The V2X-capable vehicle of claim 33, wherein the one or more V2X messages are transmitted to:
other V2X-capable vehicles,
a network entity, or
any combination thereof.

37. The V2X-capable vehicle of claim 28, wherein the one or more processors, either alone or in combination, are further configured to:
receive, via the one or more transceivers, a configuration to report V2X messages for at least a first region of the BEV space and to report BEV features for at least a second region of the BEV space, wherein the one or more features of the BEV space are one or more BEV features of the second region of the BEV space.

38. The V2X-capable vehicle of claim 28, wherein the one or more processors, either alone or in combination, are further configured to:
receive, via the one or more transceivers, a configuration to report a first type of V2X messages for at least a first region of the BEV space and to report a second type of V2X messages for at least a second region of the BEV space.

39. The V2X-capable vehicle of claim 28, wherein the one or more processors, either alone or in combination, are further configured to:
receive, via the one or more transceivers, a configuration to report a first type of V2X messages for at least a first region of the BEV space for a first time period and to report a second type of V2X messages for at least a second region of the BEV space for a second time period.

40. The V2X-capable vehicle of claim 28, wherein the one or more processors, either alone or in combination, are further configured to:
receive, via the one or more transceivers, a configuration to report BEV features for at least a region of the BEV space based on at least the region of the BEV space not being reported by other V2X-capable vehicles.

41. The V2X-capable vehicle of claim 28, wherein:
each feature of the set of BEV features is represented by a set of matrix elements of an image.

42. The V2X-capable vehicle of claim 28, wherein the one or more messages are transmitted to:
other V2X-capable vehicles,
a network entity, or
any combination thereof.

43. A network entity, comprising:
one or more memories;
one or more transceivers; and
one or more processors communicatively coupled to the one or more memories and the one or more transceivers, the one or more processors, either alone or in combination, configured to:
receive, via the one or more transceivers, from a first V2X-capable vehicle, one or more first messages indicating an association between one or more first features of a first bird's eye view (BEV) space around the first V2X-capable vehicle and one or more first V2X messages, wherein the one or more first features of the first BEV space is associated with the one or more first V2X messages based on one or more first objects detected in the one or more first features of the first BEV space being reported in the one or more first V2X messages, and wherein the one or more first messages further indicate a first set of BEV features representing the BEV space other than the one or more first features of the first BEV space associated with the one or more first V2X messages; and
determine an occupancy of a global BEV space based, at least in part, on properties of the one or more first objects reported in the one or more first V2X messages.

44. The network entity of claim 43, wherein:
the one or more first V2X messages indicate the properties of the one or more first objects at a first time, and
the occupancy of the global BEV space is determined for a second time after the first time based on the properties of the one or more first objects at a first time.

45. The network entity of claim 43, wherein the properties of the one or more first objects include:
positions of the one or more first objects,
velocities of the one or more first objects,
accelerations of the one or more first objects,
headings of the one or more first objects,
object types of the one or more first objects, or
any combination thereof.

46. The network entity of claim 43, wherein the one or more processors, either alone or in combination, are further configured to:
receive, via the one or more transceivers, from a second V2X-capable vehicle, one or more second messages indicating an association between a second feature of a second BEV space around the second V2X-capable vehicle and one or more second V2X messages, wherein the second feature of the second BEV space is associated with the one or more second V2X messages based on one or more second objects detected in the second feature of the second BEV space being reported in the one or more second V2X messages, and wherein the one or more second messages further indicate a second set of BEV features representing the second BEV space, and wherein the second set of BEV features does not include the second feature of the second BEV space associated with the one or more second V2X messages.

47. The network entity of claim 43, wherein the one or more first messages indicate the association based on the one or more first messages including:
message identifiers of the one or more first V2X messages,
object identifiers of the one or more first objects included in the one or more first V2X messages, or
any combination thereof.

48. The network entity of claim 43, wherein the one or more first messages indicate the association based on the one or more first messages indicating:
a bounding box within the first BEV space,
a set of coordinates within the first BEV space, or
a set of matrix elements within the first BEV space.

49. The network entity of claim 43, wherein:
the one or more first V2X messages include a message identifier of a most recent V2X message that included velocity vectors for the one or more first objects,
the one or more first V2X messages include current trajectories of the one or more first objects based on the current trajectories differing from previously reported trajectories of the one or more first objects,
the one or more first V2X messages include accelerations of the one or more first objects detected since the most recent V2X message including the velocity vectors for the one or more first objects,
the one or more first V2X messages do not include object classifications of the one or more first objects based on the object classifications having been previously reported,
the one or more first V2X messages include behavior identifiers of the one or more first objects indicating motion patterns of the one or more first objects, or
any combination thereof.

50. The network entity of claim 43, wherein the one or more processors, either alone or in combination, are further configured to:
transmit, via the one or more transceivers, to the first V2X-capable vehicle, a configuration to report V2X messages for at least a first region of the first BEV space and to report BEV features for at least a second region of the first BEV space, wherein the one or more first features of the first BEV space are one or more BEV features of the second region of the first BEV space.

51. The network entity of claim 43, wherein the one or more processors, either alone or in combination, are further configured to:
transmit, via the one or more transceivers, to the first V2X-capable vehicle, a configuration to report a first type of V2X messages for at least a first region of the BEV space and to report a second type of V2X messages for at least a second region of the BEV space.

52. The network entity of claim 43, wherein the one or more processors, either alone or in combination, are further configured to:
transmit, via the one or more transceivers, to the first V2X-capable vehicle, a configuration to report a first type of V2X messages for at least a first region of the BEV space for a first time period and to report a second type of V2X messages for at least a second region of the BEV space for a second time period.

53. The network entity of claim 43, wherein the one or more processors, either alone or in combination, are further configured to:
transmit, via the one or more transceivers, to the first V2X-capable vehicle, a configuration to report BEV features for at least a region of the BEV space based on at least the region of the BEV space not being reported by other V2X-capable vehicles.

54. The network entity of claim 43, wherein:
each feature of the first set of BEV features is represented by a set of matrix elements of an image.

55. A vehicle-to-everything (V2X)-capable vehicle, comprising:
means for determining an association between one or more features of a bird's eye view (BEV) space around the V2X-capable vehicle and one or more V2X messages, wherein the one or more features of the BEV space are associated with the one or more V2X messages based on one or more objects detected in the one or more features of the BEV space being reported in the one or more V2X messages; and
means for transmitting one or more messages indicating the association and a set of BEV features representing the BEV space other than the one or more features of the BEV space associated with the one or more V2X messages.

56. A network entity, comprising:
means for receiving, from a first V2X-capable vehicle, one or more first messages indicating an association between one or more first features of a first bird's eye view (BEV) space around the first V2X-capable vehicle and one or more first V2X messages, wherein the one or more first features of the first BEV space is associated with the one or more first V2X messages based on one or more first objects detected in the one or more first features of the first BEV space being reported in the one or more first V2X messages, and wherein the one or more first messages further indicate a first set of BEV features representing the BEV space other than the one or more first features of the first BEV space associated with the one or more first V2X messages; and
means for determining an occupancy of a global BEV space based, at least in part, on properties of the one or more first objects reported in the one or more first V2X messages.

57. A non-transitory computer-readable medium storing computer-executable instructions that, when executed by a vehicle-to-everything (V2X)-capable vehicle, cause the V2X-capable vehicle to:
determine an association between one or more features of a bird's eye view (BEV) space around the V2X-capable vehicle and one or more V2X messages, wherein the one or more features of the BEV space are associated with the one or more V2X messages based on one or more objects detected in the one or more features of the BEV space being reported in the one or more V2X messages; and
transmit one or more messages indicating the association and a set of BEV features representing the BEV space other than the one or more features of the BEV space associated with the one or more V2X messages.

58. A non-transitory computer-readable medium storing computer-executable instructions that, when executed by a network entity, cause the network entity to:
receive, from a first V2X-capable vehicle, one or more first messages indicating an association between one or more first features of a first bird's eye view (BEV) space around the first V2X-capable vehicle and one or more first V2X messages, wherein the one or more first features of the first BEV space is associated with the one or more first V2X messages based on one or more first objects detected in the one or more first features of the first BEV space being reported in the one or more first V2X messages, and wherein the one or more first messages further indicate a first set of BEV features representing the BEV space other than the one or more first features of the first BEV space associated with the one or more first V2X messages; and
determine an occupancy of a global BEV space based, at least in part, on properties of the one or more first objects reported in the one or more first V2X messages.
